(19) United States
(12) Patent Application Publication
(10) Pub. No.: US 2026/0270723 A1
(43) Pub. Date: Sep. 10, 2026

(54) LANGUAGE MODEL-BASED DOWNLINK GRANT PREDICTION

(71) Applicant: QUALCOMM Incorporated, San Diego, CA (US)

(72) Inventors: Himanshu JOSHI, San Jose, CA (US); Vinay CHANDE, San Diego, CA (US); June NAMGOONG, San Diego, CA (US); Taesang YOO, San Diego, CA (US)

(21) Appl. No.: 19/073,567

(22) Filed: Mar. 7, 2025

(51) Int. Cl. H04W 24/02; H04L 1/1867; H04L 1/20; H04L 5/00; H04W 72/115; H04W 76/28

(52) U.S. Cl. CPC H04W 24/02; H04L 1/188; H04L 1/1896; H04L 1/203; H04L 5/0005; H04W 72/115; H04W 76/28

(57) ABSTRACT

Certain aspects of the present disclosure provide techniques for language model-based downlink grant prediction. An example method includes providing, to one or more generative artificial intelligence (AI) language models, input data including information associated with past communications, wherein the one or more generative AI language models are pre-trained based at least in part on training data that includes one or more training tokens associated with a wireless communication protocol; obtaining, from the one or more generative AI language models, output data that includes an indication of one or more downlink grant predictions; and communicating based at least in part on the output data.

### INTRODUCTION

### Field of the Disclosure

Aspects of the present disclosure relate to wireless communications, and more particularly, to techniques for downlink grant prediction.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

In certain cases, a user equipment (UE) may be configured with a discontinuous reception (DRX) cycle. During the DRX cycle, the UE may be in a sleep state for an inactive time period and monitor for downlink signaling during an active time period. Thus, the DRX cycle may enable the UE to implement certain power savings. However, the channel usage and/or power savings may depend on certain timers configured for the DRX cycle. Aspects of the present disclosure provide pre-trained generative artificial intelligence (AI) language model-based downlink grant prediction, which may enable reduced power consumption and/or improved channel usage, for example, for DRX cycle management. As an example, the reduced power consumption may be attributable to the downlink grant predictions enabling a UE to extend a sleep state and/or end an on duration before a timer expires. As another example, the downlink grant predictions may indicate that certain UE(s) may have similar downlink traffic patterns, and thus, a network node may configure such UEs with DRX cycles that overlap in time, which may enable improved channel usage.

Certain aspects provide a method for wireless communications by a user equipment (UE). The method includes providing, to one or more generative artificial intelligence (AI) language models, input data including information associated with past communications, wherein the one or more generative AI language models are pre-trained based at least in part on training data that includes one or more training tokens associated with a wireless communication protocol; obtaining, from the one or more generative AI language models, output data that includes an indication of one or more downlink grant predictions; and communicating based at least in part on the output data.

Certain aspects provide a method for wireless communications by a network node. The method includes providing, to one or more generative AI language models, input data including information associated with past communications, wherein the one or more generative AI language models are pre-trained based at least in part on training data that includes one or more training tokens associated with a wireless communication protocol; obtaining, from the one or more generative AI language models, output data that includes an indication of one or more downlink grant predictions; and communicating with one or more UEs based at least in part on the output data.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example artificial intelligence (AI) architecture that may be used for AI-enhanced wireless communications.

FIG. 6 depicts an example AI architecture of a first wireless device that is in communication with a second wireless device.

FIG. 7 depicts an example artificial neural network.

FIG. 8 depicts an example of a discontinuous reception (DRX) configuration.

FIG. 9 depicts an example of certain timers associated with a DRX configuration.

FIG. 10 depicts an example generative AI language model trained to predict one or more downlink grants over a time window.

FIG. 11 depicts an example scheme of applying language model-based downlink grant predictions to DRX cycle management.

FIG. 12 depicts an example scheme of predicting transmission bursts based on downlink grant predictions.

FIG. 13 depicts a process flow for language model-based downlink grant prediction.

FIG. 14 depicts a method for wireless communications.

FIG. 15 depicts another method for wireless communications.

FIG. 16 depicts aspects of an example communications device.

FIG. 17 depicts aspects of an example communications device.

### DETAILED DESCRIPTION

Aspects of the present disclosure provide apparatuses, methods, processing systems, and computer-readable mediums for language model-based downlink grant prediction.

Certain wireless communication systems (e.g., a 5G New Radio (NR) system) may implement various power saving techniques. Two example power saving techniques include discontinuous reception (DRX) and discontinuous transmission (DTX). DRX may provide for reception operations of a wireless communication device, such as a user equipment (UE) or a network node (e.g., a base station), to be deactivated during some time intervals, which may be referred to as off durations, inactive time periods, or non-active time periods. DTX may provide for transmission operations of a wireless communications device to be deactivated during similar such time intervals. A given wireless communications device may be configured for DRX and/or DTX.

Accordingly, DRX and/or DTX may provide a way for a wireless communication device to save power during a periodic off duration in which the wireless communication device does not perform some form of communication. During a periodic on duration, the wireless communication device performs communications (such as by monitoring a physical downlink control channel (PDCCH) for DRX or sending an uplink transmission for DTX.

At the network node, DTX may be referred to as “cell DTX”, and DRX may be referred to as “cell DRX.” Thus, the network node may cease or restrict transmission and/or reception in certain time intervals in accordance with cell DTX and/or cell DTX (collectively referred to herein as “cell DTX/DRX”). Cell DTX/DRX may allow the network node to enter a low power state such as a sleep state in a time interval, so long as communications to and from the network node can successfully be avoided in the time interval. Thus, cell DTX/DRX may be referred to as a network energy saving technique.

A UE may implement a connected-mode DRX (C-DRX) cycle while the UE is connected to a network node. In a C-DRX cycle, the UE may periodically enter an on duration and monitor for a PDCCH. If the UE detects a PDCCH in the on duration, the UE may extend the on duration in accordance with a DRX inactivity timer, and may continue to monitor for further PDCCHs or perform other communications while in an active state. After the DRX inactivity timer has expired (or if the UE does not detect any PDCCH in the DRX on duration), the UE may enter a sleep state during an off duration. In the sleep state, certain circuitry of the UE, such as radio frequency circuitry or a receive chain, may be powered down or in a low power state. Upon reaching a next DRX on duration, the UE may power up the circuitry and monitor for a PDCCH.

A C-DRX cycle may be configured using various parameters. For example, the DRX inactivity timer defined above may indicate how long a DRX on duration is extended when a PDCCH is received during the DRX on duration. As another example, a slot offset may indicate a slot in which a DRX on duration of the C-DRX cycle is to start with respect to the beginning of a subframe. As another example, a DRX cycle length may indicate a length of time from the start of a DRX on duration to a start of a next DRX on duration. As another example, a hybrid automatic repeat request (HARQ) round-trip time (RTT) timer and a HARQ retransmission timer may indicate time intervals associated with retransmission of a communication during a DRX cycle. These parameters may generally be configured via semi-static signaling, such as radio resource control (RRC) signaling.

Technical problems for a DRX cycle may include, for example, effective channel usage and/or power consumption during a DRX cycle. As discussed, a DRX cycle relies on the configuration and expiration of certain timers (such as the DRX inactivity timer, HARQ RTT timer, and/or the HARQ retransmission timer) to determine the duration of the active time (e.g., on duration) and the duration of the inactive time (e.g., off duration) of a DRX cycle. Thus, a UE may use a non-trivial amount of power monitoring for signaling while one of those timers is running regardless of whether a downlink transmission is received. In certain cases, the network node may reserve a non-trivial amount of downlink channel resources (e.g., frequency resources) for downlink signaling during at least a portion of the on duration of the DRX cycle. The downlink channel resources allocated for the DRX cycle may increase as the number of UEs served by a network node increases.

Aspects described herein may overcome the aforementioned technical problem(s), for example, by providing pre-trained generative artificial intelligence (AI) language model-based downlink grant prediction, which may enable reduced power consumption and/or improved channel usage, as further described herein. The generative AI language model may be trained using training tokens associated with a wireless communication protocol. The training tokens may indicate characteristics of a communication link between a UE and a network node (e.g., a downlink rank, modulation and coding scheme (MCS), block error rate (BLER), or the like). In certain aspects, a UE and/or network node may generate or obtain downlink grant predictions based on the pre-trained generative AI language model. In certain cases, the UE and/or the network node may configure one or more communication parameters (such as the DRX cycle configuration) based on downlink grant predictions.

In certain cases, the downlink grant predictions may enable the UE to determine whether to monitor for downlink signaling during the active time of a DRX cycle. As an example, the UE may remain in a sleep state based on the downlink grant prediction(s) indicating that there are no downlink transmissions expected to be received during the on duration of the DRX cycle. As another example, the UE may prematurely terminate a timer (such as the DRX inactivity timer, HARQ RTT timer, and/or the HARQ retransmission timer) based on the downlink grant prediction(s) indicating that there are no downlink transmissions expected to be received during the timer. As another example, the UE may prepare for a downlink transmission during the on duration based on the downlink grant prediction(s) indicating that the downlink transmission is expected to be received during the on duration of the DRX cycle.

In certain cases, the downlink grant predictions may enable the network node to allocate, to one or more UEs, communication resources (e.g., PDCCH monitoring occasions) associated with the DRX cycle. As an example, the network node may configure a set of UEs with the same DRX cycle configuration based on the downlink grant predictions indicating that the set of UEs have similar traffic patterns.

Certain techniques for language model-based downlink grant prediction described herein may provide various beneficial technical effects and/or advantages. The techniques for language model-based downlink grant prediction may enable improved wireless communications performance, such as reduced power consumption, improved channel usage, and/or the like. The reduced power consumption may be attributable to the downlink grant predictions enabling a UE to adjust a duration of an inactive time period and a duration of an active time period of a DRX cycle. The UE may extend a sleep state and/or end an on duration before a timer expires. For example, the UE may extend the inactive time period based on downlink grant predictions indicating that there are no downlink transmissions expected to be received during a configured active time period.

In certain cases, the improved channel usage may be attributable to the downlink grant predictions enabling a network node to configure certain UEs with the same DRX cycles. As an example, the downlink grant predictions may indicate that certain UEs may have similar downlink traffic patterns, and thus, the network node may configure such UEs with DRX cycles that overlap in time. The overlapping DRX cycles may enable the network node to allocate certain communication resources to other communications, and thus, improving the channel usage.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

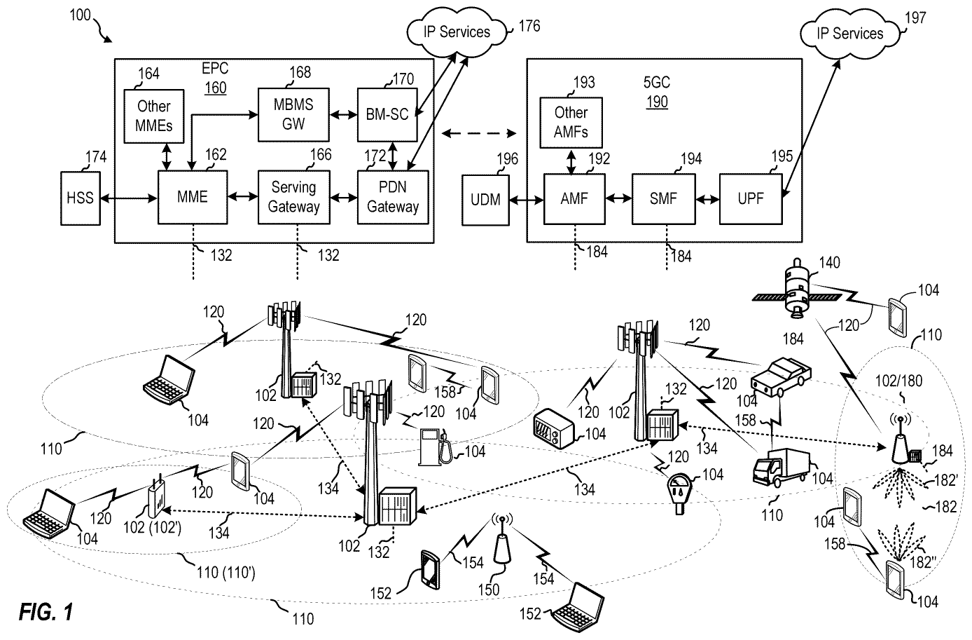

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

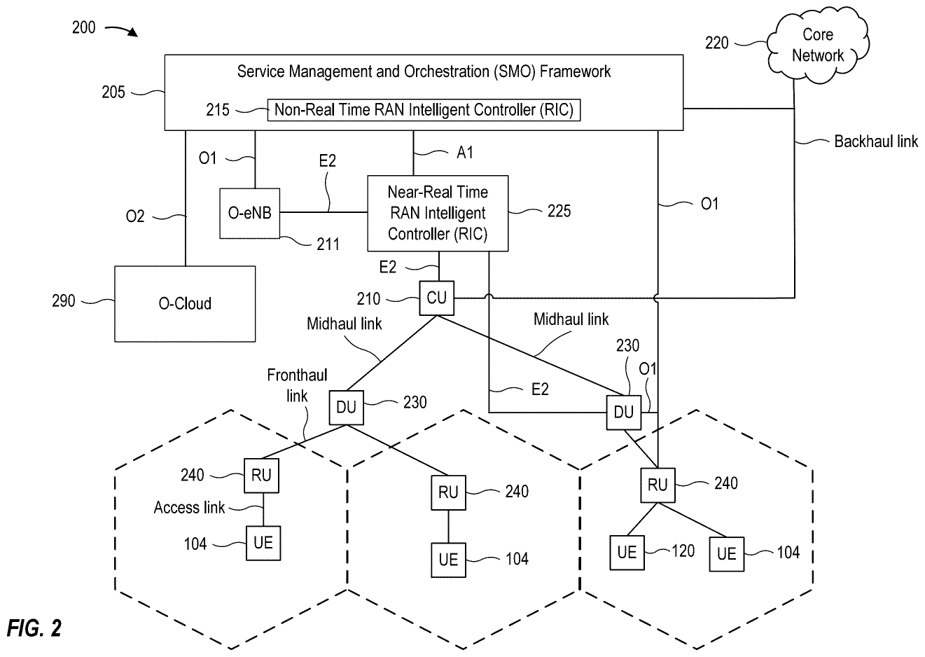

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

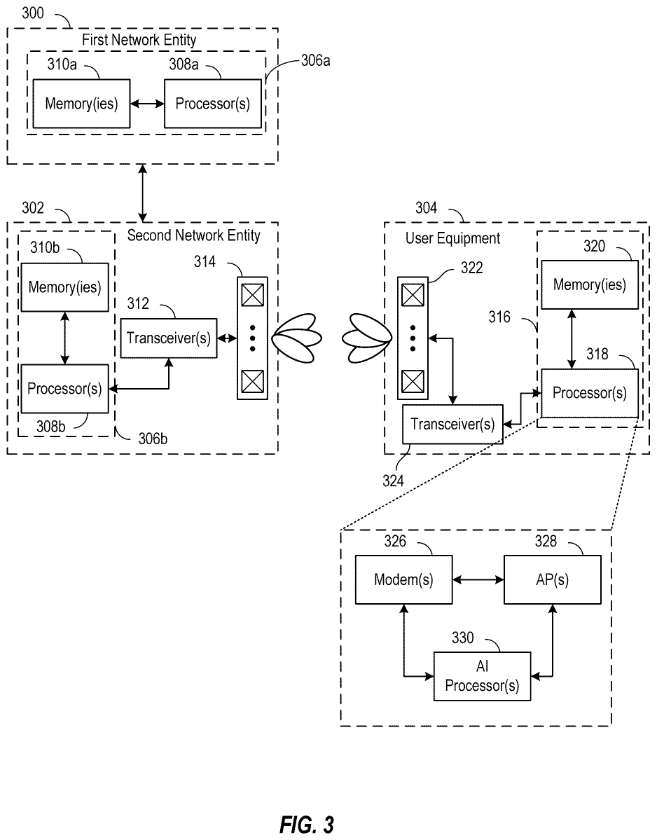

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

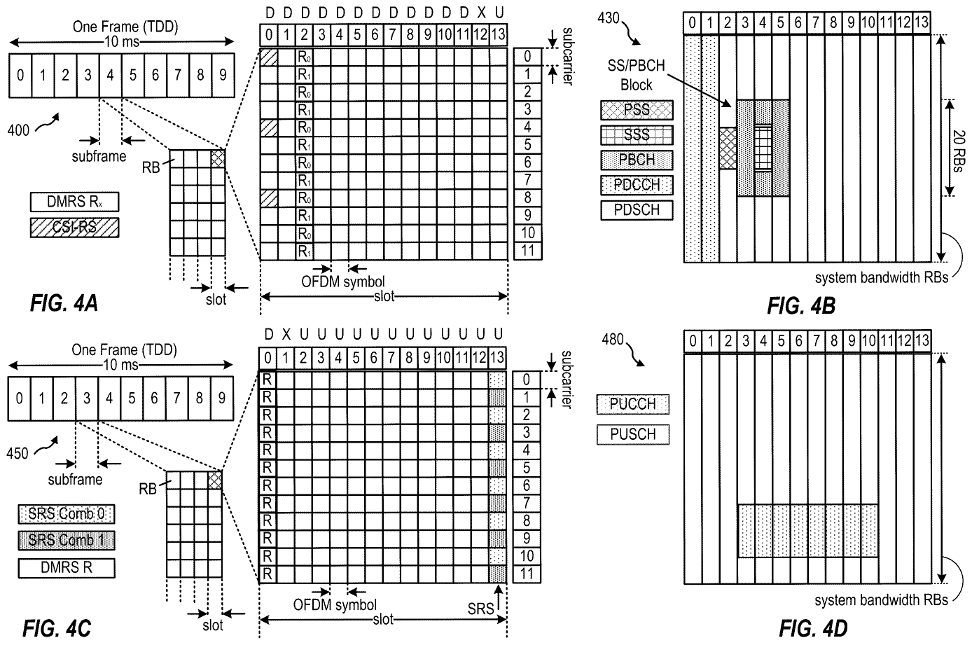

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained AI model,” and the like are intended to be interchangeable.

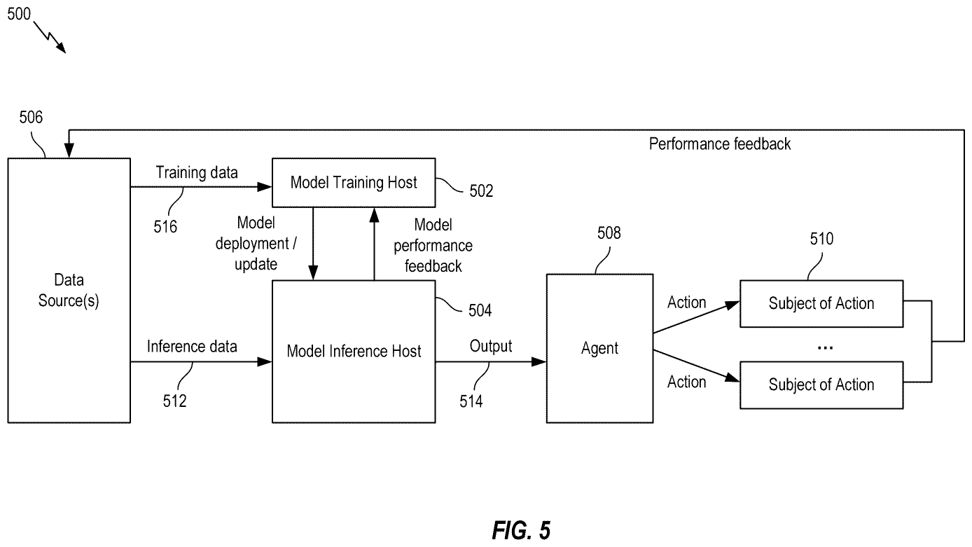

FIG. 5 is a diagram illustrating an example AI architecture 500 that may be used for AI-enhanced wireless communications. As illustrated, the architecture 500 includes multiple logical entities, such as a model training host 502, a model inference host 504, data source(s) 506, and an agent 508. The AI architecture may be used in any of various use cases for wireless communications, such as those listed above.

The model inference host 504, in the architecture 500, is configured to run an ML model based on inference data 512 provided by data source(s) 506. The model inference host 504 may produce an output 514 (e.g., a prediction or inference, such as a discrete or continuous value) based on the inference data 512, that is then provided as input to the agent 508. In certain aspects, the model inference host 504 may be an example of a model inference agent.

The agent 508 may be an element or an entity of a wireless communication system including, for example, a radio access network (RAN), a wireless local area network, a device-to-device (D2D) communications system, etc. In certain examples, the agent 508 may be an example of a decision agent. In some examples, the agent 508 may be a UE, a base station, or any disaggregated network entity thereof including a CU, a DU, and/or an RU, an access point, a wireless station, a RIC in a cloud-based RAN, among some examples. Additionally, the type of agent 508 may also depend on the type of tasks performed by the model inference host 504, the type of inference data 512 provided to model inference host 504, and/or the type of output 514 produced by model inference host 504.

For example, if output 514 from the model inference host 504 is associated with beam management, the agent 508 may be or include a UE, a DU, or an RU. As another example, if output 514 from model inference host 504 is associated with transmission and/or reception scheduling, the agent 508 may be a CU or a DU.

After the agent 508 receives output 514 from the model inference host 504, agent 508 may determine whether to act based on the output. For example, if agent 508 is a DU or an RU and the output from model inference host 504 is associated with downlink grant predictions (as further described herein), the agent 508 may determine whether to change or modify certain downlink communication parameters (e.g., CSI reporting, semi-persistent scheduling, DRX cycle, or the like) based on the output 514. If the agent 508 determines to act based on the output 514, agent 508 may indicate the action to at least one subject of the action 510. For example, if the agent 508 determines to change or modify parameters for a communication between the agent 508 and the subject of action 510 (e.g., a UE), the agent 508 may send reconfiguration message to the subject of action 510 (e.g., a UE). As another example, the agent 508 may be a UE, the output 514 from model inference host 504 may be one or more downlink grant predictions for a future time window. For example, the model inference host 504 may predict that downlink transmissions are not expected to be received in the future time window. Based on the predicted downlink activity, the agent 508, such as the UE, may remain in a sleep state regardless of a configured DRX cycle, as further described herein. In some cases, the agent 508 and the subject of action 510 are the same entity.

The data sources 506 may be configured for collecting data that is used as training data 516 for training an ML model, or as inference data 512 for feeding an ML model inference operation. In particular, the data sources 506 may collect data from any of various entities (e.g., the UE and/or the BS), which may include the subject of action 510, and provide the collected data to a model training host 502 for ML model training. For example, after a subject of action 510 (e.g., a UE) receives a beam configuration from agent 508, the subject of action 510 may provide performance feedback associated with the beam configuration to the data sources 506, where the performance feedback may be used by the model training host 502 for monitoring and/or evaluating the ML model performance, such as whether the output 514, provided to agent 508, is accurate. In some examples, if the output 514 provided to agent 508 is inaccurate (or the accuracy is below an accuracy threshold), the model training host 502 may determine to modify or retrain the ML model used by model inference host 504, such as via an ML model deployment/update.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In certain aspects, an ML model is deployed at or on a network node (e.g., the BS 102 of FIG. 1) for language model-assisted wireless communications. More specifically, a model inference host, such as model inference host 504 in FIG. 5, may be deployed at or on the network entity for language model-based downlink grant prediction.

In certain aspects, an ML model is deployed at or on a UE (such UE 104 of FIG. 1) for language model-assisted wireless communications. More specifically, a model inference host, such as model inference host 504 in FIG. 5, may be deployed at or on the UE for language model-based downlink grant prediction.

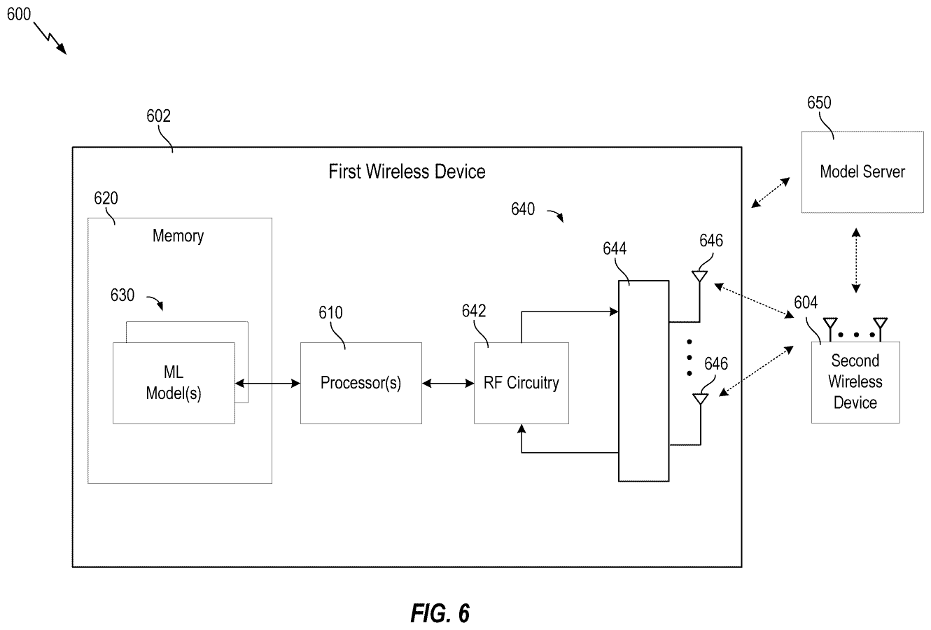

FIG. 6 illustrates an example AI architecture 600 of a first wireless device 602 that is in communication with a second wireless device 604. The first wireless device 602 may be a UE as described herein with respect to FIGS. 1-3. Similarly, the second wireless device 604 may be a network entity or network node as described herein with respect to FIGS. 1-3. Note that the AI architecture of the first wireless device 602 may be applied to the second wireless device 604.

The first wireless device 602 may be, or may include, a chip, system on chip (SoC), a system in package (SiP), chipset, package or device that includes one or more processors, processing blocks or processing elements (hereinafter “the processor 610”) and one or more memory blocks or elements (hereinafter “the memory 620”). The processor 610 may be an example of the one or more processors 318 of FIG. 3, and the memory 620 may be an example of the one or more memories 320 of FIG. 3.

As an example, in a transmit mode, the processor 610 may transform information (e.g., packets or data blocks) into modulated symbols. As digital baseband signals (e.g., digital in-phase (I) and/or quadrature (Q) baseband signals representative of the respective symbols), the processor 610 may output the modulated symbols to a transceiver 640. The processor 610 may be coupled to the transceiver 640 for transmitting and/or receiving signals via one or more antennas 646. In this example, the transceiver 640 includes radio frequency (RF) circuitry 642, which may be coupled to the antennas 646 via an interface 644. As an example, the interface 644 may include a switch, a duplexer, a diplexer, a multiplexer, and/or the like. The RF circuitry 642 may convert the digital signals to analog baseband signals, for example, using a digital-to-analog converter. The RF circuitry 642 may include any of various circuitry, including, for example, baseband filter(s), mixer(s), frequency synthesizer(s), power amplifier(s), and/or low noise amplifier(s). In some cases, the RF circuitry 642 may upconvert the baseband signals to one or more carrier frequencies for transmission. The antennas 646 may emit RF signals, which may be received at the second wireless device 604.

In receive mode, RF signals received via the antenna 646 (e.g., from the second wireless device 604) may be amplified and converted to a baseband frequency (e.g., downconverted). The received baseband signals may be filtered and converted to digital I or Q signals for digital signal processing. The processor 610 may receive the digital I or Q signals and further process the digital signals, for example, demodulating the digital signals.

One or more ML models 630 may be stored in the memory 620 and accessible to the processor 610. In certain cases, different ML models 630 with different characteristics may be stored in the memory 620, and a particular ML model 630 may be selected based on its characteristics and/or application as well as characteristics and/or conditions of first wireless device 602 (e.g., a power state, a mobility state, a battery reserve, a temperature, etc.). For example, the ML models 630 may have different inference data and output pairings (e.g., different types of inference data produce different types of output), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

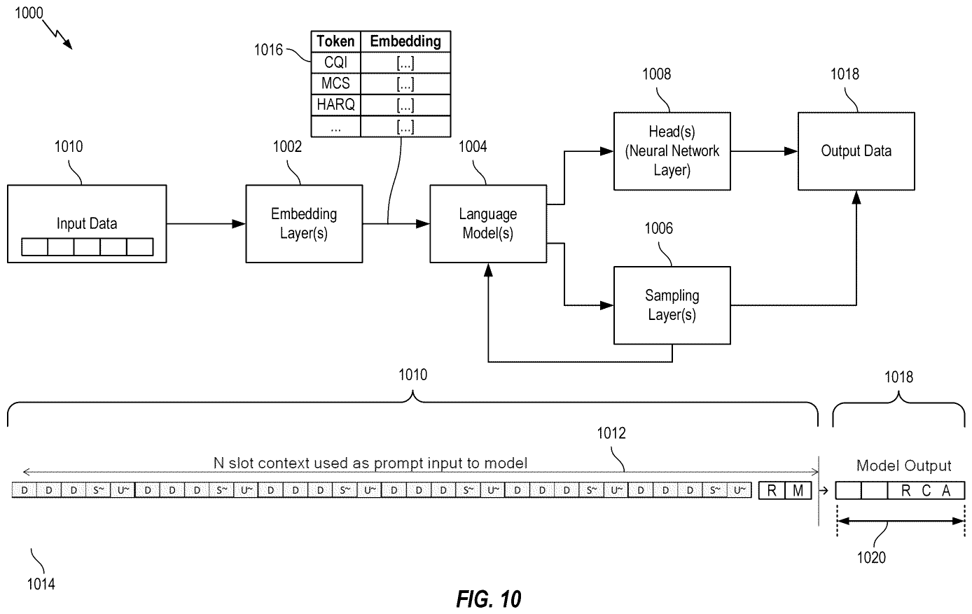

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks described herein. The ML model 603 may be or include a pre-trained generative AI model as further described herein with respect to FIG. 10.

As an example, the ML model 630 may take wireless communication protocol data as input to predict one or more downlink grants in a future time window, for example, as further described herein with respect to FIG. 10. The input data may include, for example, a sequence of tokens representative or indicative of historical or simulated wireless communication configuration(s), link activity, and/or channel condition(s) over a time window. The output data may include, for example, one or more predicted downlink grants for a future time window, for example, 16 slots, 32 slots, or the like. As an example, the downlink grant prediction(s) may enable the first wireless device 602 to reliably receive downlink transmissions and/or determine when to enter a sleep state to reduce power consumption. Note that other input data and/or output data may be used in addition to or instead of the examples described herein.

In certain aspects, a model server 650 may perform any of various ML model lifecycle management (LCM) tasks for the first wireless device 602 and/or the second wireless device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first wireless device 602 and/or the second wireless device 604 to download.

In some cases, the model server 650 may monitor and evaluate the performance of the ML model 630 to trigger one or more LCM tasks. For example, the model server 650 may determine whether to activate or deactivate the use of a particular ML model at the first wireless device 602 and/or the second wireless device 604, and the model server 650 may provide such an instruction to the respective first wireless device 602 and/or the second wireless device 604. In some cases, the model server 650 may determine whether to switch to a different ML model 630 being used at the first wireless device 602 and/or the second wireless device 604, and the model server 650 may provide such an instruction to the respective first wireless device 602 and/or the second wireless device 604. In yet further examples, the model server 650 may also act as a central server for decentralized machine learning tasks, such as federated learning.

### Example Artificial Intelligence Model

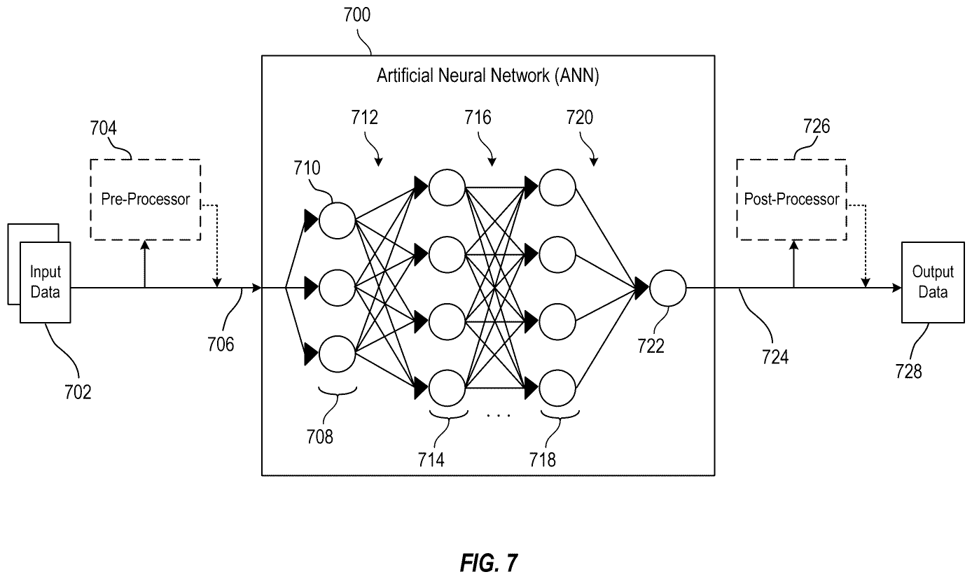

FIG. 7 is an illustrative block diagram of an example artificial neural network (ANN) 700.

ANN 700 may receive input data 706 which may include one or more bits of data 702, pre-processed data output from pre-processor 704 (optional), or some combination thereof. Here, data 702 may include training data, verification data, application-related data, or the like, e.g., depending on the stage of development and/or deployment of ANN 700. Pre-processor 704 may be included within ANN 700 in some other implementations. Pre-processor 704 may, for example, process all or a portion of data 702 which may result in some of data 702 being changed, replaced, deleted, etc. In some implementations, pre-processor 704 may add additional data to data 702.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 506 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc. Once an initial model has been designed, training of the model may be conducted using training data. Training data may include one or more datasets within which ANN 700 may detect, determine, identify or ascertain patterns. Training data may represent various types of information, including written, visual, audio, environmental context, operational properties, etc. During training, parameters of artificial neurons 710 may be changed, such as to minimize or otherwise reduce a loss function or a cost function. A training process may be repeated multiple times to fine-tune ANN 700 with each iteration.

Various ANN model structures are available for consideration. For example, in a feedforward ANN structure each artificial neuron 710 in a layer receives information from the previous layer and likewise produces information for the next layer. In a convolutional ANN structure, some layers may be organized into filters that extract features from data (e.g., training data and/or input data). In a recurrent ANN structure, some layers may have connections that allow for processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences. The output of a transformer ANN structure may be obtained by applying a linear transformation to the output of a final attention layer. A transformer ANN structure may be of particular use for tasks that involve sequence modeling, or other like processing.

Another example type of ANN structure, is a model with one or more invertible layers. Models of this type may be inverted or “unwrapped” to reveal the input data that was used to generate the output of a layer.

Other example types of ANN model structures include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models.

### Aspects of Artificial Intelligence Model Training

There are a variety of model training techniques and processes that may be used prior to, or at some point following, deployment of an ML model, such as ANN 700 of FIG. 7.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more user equipments (UEs), one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ANN, such as ANN 700 of FIG. 7, parameters affecting the functioning of the artificial neurons and layers may be adjusted. For example, backpropagation techniques may be used to train the ANN by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a user equipment (UE) or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a central unit (CU), a distributed unit (DU), a radio unit (RU), or the like.

### Example Discontinuous Reception Cycle

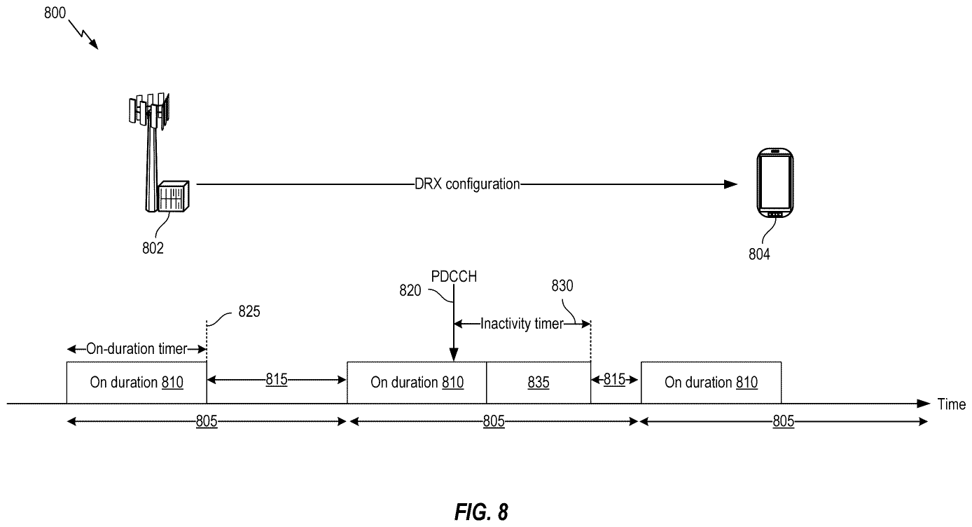

FIG. 8 depicts an example 800 of a DRX configuration. As shown, a network entity 802 may transmit, and a UE 804 may receive, a DRX configuration. The network entity 802 may be an example of the BS 102 of FIG. 1, the first network entity 300 or the second network entity 302 of FIG. 3, or a disaggregated base station as discussed with respect to FIG. 2. The UE 804 may be an example of the UE 104 of FIG. 1 or UE 304 of FIG. 3. The DRX configuration may be communicated via RRC signaling, MAC signaling, DCI, system information, and/or the like.

The DRX configuration may configure a DRX cycle 805. A DRX cycle 805 may include a DRX on duration 810 (for example, during which a UE 804 is awake or in an active state) and an opportunity to enter a DRX sleep state 815. The time during which the UE 804 is configured to be in an active state during the DRX on duration 810 plus any extension of the DRX on duration 810 (for example, due to an inactivity timer) may be referred to as an active time period of the DRX cycle 805. The time during which the UE 804 is configured to be in the DRX sleep state 815 may be referred to as an inactive time period (or a DRX off duration) of the DRX cycle 805. The UE 804 may monitor a downlink control channel (for example, a PDCCH) during the active time period, and the UE 804 may refrain from monitoring the downlink control channel during the inactive time period. In certain cases, the UE 804 may enter a lower power state during the inactive time period. Thus, the DRX cycle 805 may enable power savings at the UE 804, for example, due to periodic monitoring of the downlink control channel.

During the DRX on duration 810, the UE 804 may monitor a control channel, such as the PDCCH. For example, the UE 804 may monitor the control channel for control information (for example, DCI) pertaining to the UE 804. If the UE 804 does not detect and/or successfully decode any control channel communications addressed to the UE 804 during the DRX on duration 810, then the UE 804 may enter the sleep state 815 (for example, for the inactive time period) at the end 825 of the DRX on duration 810. In this way, the UE 804 may conserve battery power and/or reduce power consumption. As shown, the DRX cycle 805 may repeat with a configured periodicity according to the DRX configuration.

If the UE 804 detects and/or successfully decodes a control channel communication 820 addressed to the UE 804, then the UE 804 may remain in an active state (for example, awake) for the duration of a DRX inactivity timer 830 (for example, which may extend into the configured inactive time period of the current DRX cycle). The DRX inactivity timer 830 may be referred to herein as a timer parameter. The time period 835 depicts the extension of the active time period due to the DRX inactivity timer 830 being initiated. The UE 804 may start the DRX inactivity timer 830 at a time at which the control channel communication is received (for example, in a transmission-time-interval in which the control channel communication 820 is received, such as symbol, a slot, or a subframe). The UE 804 may remain in the active state until the DRX inactivity timer 830 expires, at which time the UE 804 may enter the sleep state 815 (for example, for the remainder of the inactive time period of the current DRX cycle). During the duration of the DRX inactivity timer 830, the UE 804 may continue to monitor for control channel communications, may obtain a downlink data communication (for example, on a data channel such as a PDSCH) scheduled by the control channel communication, and/or may prepare and/or transmit a communication (for example, on a PUSCH and/or a PSSCH) scheduled by the control channel communication. The UE 804 may restart the DRX inactivity timer 830 after each detection of a control channel communication for the UE 804 for an initial transmission (for example, but not, in some cases, for a retransmission). By operating in this manner, the UE 804 may conserve battery power and reduce power consumption by entering the sleep state 815.

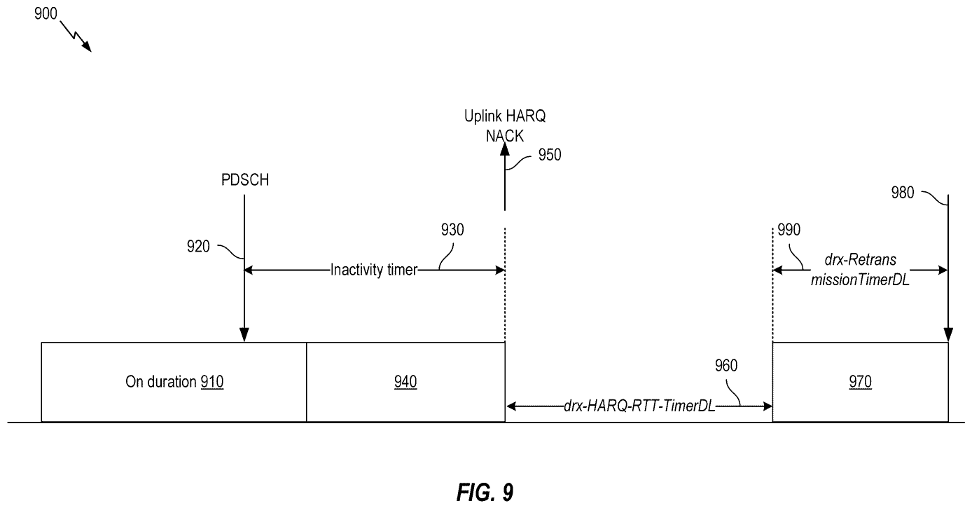

FIG. 9 depicts an example 900 of a downlink HARQ RTT timer and a downlink HARQ retransmission timer. The downlink HARQ RTT timer and the downlink HARQ retransmission timer may each be referred to herein as timer parameters. The operations of example 900 may be performed by a UE, such as the UE 804 of FIG. 8.

Example 900 includes a DRX on duration 910, which may be an example of DRX on duration 810 described with respect to FIG. 8. As shown, the UE may receive a PDSCH 920 during the DRX on duration 910. Thus, the UE may start a DRX inactivity timer 930, as described with regard to FIG. 8, and the UE may remain in an active state during the time interval 940.

In certain cases, the UE may fail to successfully decode the PDSCH 920. Thus, the UE may transmit an uplink HARQ NACK 950. Upon transmitting the uplink HARQ NACK 950, the UE may start a downlink HARQ RTT timer 960 (which may be defined by a parameter drx-HARQ-RTT-TimerDL). In some examples, the UE may enter a sleep state (such as sleep state 815) during the downlink HARQ RTT timer 960.

Upon expiration of the downlink HARQ RTT timer 960, the UE may enter an active state 970. The UE may remain in the active state 970 until a retransmission 980 of the PDSCH 920 is received, or until expiration of a downlink HARQ retransmission timer 990. For example, upon receiving the retransmission 980, the UE may stop the downlink HARQ retransmission timer 990 and may enter a sleep state (such as sleep state 815) until a next DRX on duration 910. The downlink HARQ retransmission timer 990 may be defined by a parameter such as drx-RetransmissionTimerDL.

### Aspects Related to Language Model-Based Downlink Grant Prediction

Aspects of the present disclosure provide pre-trained generative AI language model-based downlink grant prediction. The generative AI language model may generate downlink grant predictions including, for example, future grant latency, transmission burst characteristics (e.g., burst duration and expected arrival times), and retransmission probability. In certain cases, the downlink grant predictions may be derived from predictions of a block error rate (BLER) on the next grant or transmission burst. The downlink grant predictions may enable reduced power consumption, improved channel usage, enhanced reliability in downlink communications, and/or the like as further described herein.

FIG. 10 depicts an example generative AI language model 1000 trained to predict one or more downlink grants over a time window. In this example, the generative AI language model 1000 may include one or more embedding layers (hereinafter “the embedding layer 1002”), one or more language models (hereinafter “the language model 1004”), and one or more sampling layers (hereinafter “the sampling layer 1006”). In certain cases, the generative AI language model may further include one or more task-specific heads (hereinafter “the task-specific head 1008”). The generative AI language model may be an AI model that is configured to transform one or more tokens representing wireless communication protocol data over a time window into one or more downlink grant predictions over a future time window.

In certain aspects, the generative AI language model 1000 may be deployed at or on a UE (such as the UE 104, 304 and/or the first wireless device 602) to perform language model-based downlink grant prediction as further described herein. In certain aspects, the generative AI language model 1000 may be deployed at or on a network node (such as the BS 102, the first network entity 300, the second network entity 302, the second wireless device 604, the model server 650, and/or the like) to perform language model-based downlink grant prediction as further described herein.

As an example, the generative AI language model 1000 may be deployed at or on a model server (e.g., the model server 650) in communication with the UE and/or a network node. The UE may send input data to the model server. The model server may generate output data using the generative AI language model 1000 based at least in part on the input data obtained from the UE. The UE may obtain, from the model server, one or more downlink grant predictions as further described herein.

In certain aspects, the generative AI language model 1000 (e.g., the embedding layer 1002, the language model 1004, the sampling layer 1006, and/or the task-specific head 1008) may be pre-trained specifically using a large diverse dataset of wireless communication data, tokenized in a suitable format. In certain cases, the generative AI language model 1000 may be trained without any natural language data, such as natural language resources including text from websites, books, journals, magazines, newspapers, or the like. In this way, the generative AI language model 1000 may be specifically pre-trained to process tokens that represent wireless communication protocol signals and/or associated values, which may indicate, for example, configuration(s), link activities, user behavior, and/or condition(s) over a time window, as further described herein. In certain cases, the generative AI language model 1000 may be referred to as a generative AI wireless language model, for example, due to the wireless communication protocol data used to train the generative AI language model. The generative AI language model 1000 may be pre-trained, which may mean that the AI language model has undergone at least an initial training phase using a diverse training dataset. Accordingly, the pretraining of the generative AI language model 1000 may enable reliable and accurate predictions of future wireless communication activities.

Input data 1010 may be fed or provided to the embedding layer 1002. The input data 1010 may include information associated with communications between certain wireless communication devices, such as a UE and a network node. In certain cases, the information may include data associated with simulated communications (or hypothetical communications) and/or past (or historical) communications between a UE and a network node. In certain cases, the input data 1010 may include one or more settings applied or used at a network node (which may not be available to the UE), for example, when the network node is performing inference operations of the generative AI language model 1000.

The input data 1010 may be or include an N slot context (e.g., a context length of tokens representing N slots), over a time window, with information associated with each of the slots 1014. The context length may be the total number of tokens the generative AI language model 1000 is processing at a given occasion in time as the input of a prompt including any tokens appended to the input as part of autoregressive inference. The information associated with the communications may indicate one or more wireless communication activities, conditions, and/or configurations over a time window 1012, such as N transmission time intervals, N slots, or a specific duration. The information may indicate the activity, condition, and/or configuration for each transmission time interval or slot over the time window 1012. For example, the information may indicate or include, for each slot 1014, one or more characteristics associated with the respective slot. The characteristic(s) may include, for example, but not limited to, a downlink rank (or a total number of MIMO layers), a modulation and coding scheme (MCS), code rate, a frequency resource allocation, a time domain resource allocation, one or more channel state information (CSI) reports (or measurement report(s)), HARQ feedback (e.g., an ACK, a NACK, ACK/NACK ratio, ACK/NACK rate, or the like), one or more beams (or associated reference signal(s)), or any combination thereof. Accordingly, the characteristic(s) associated with a given slot may indicate the activity, condition (e.g., channel conditions), and/or configuration for the communication link between a UE and a network node at the given slot.

In certain aspects, the input data 1010 may be tokenized (e.g., converted to a set of tokens) or include a set of tokens associated with a wireless communication protocol. The set of tokens may be arranged in an ordered sequence, for example, according to a time sequence associated with the N transmission time intervals (or slots). Each token of the set of tokens may indicate the presence of certain protocol elements or the characteristic(s) (e.g., downlink rank, MCS, BLER, and/or the like) associated with a communication link between a UE and a network node. As part of the language model 1004, the token vocabulary may be based on the wireless communication protocol, or network/UE settings, or conditions of the channel, link, etc. The token vocabulary may implicitly and/or explicitly indicate a TDD frame pattern, HARQ feedback behaviors, retransmission behaviors, CSI report, BLER, and/or the like. In certain cases, the input data 1010 may include at least one previous downlink grant prediction. For example, a previously predicted token may be provided to the language model 1004 as an aspect of autoregressive inference further discussed below.

The embedding layer 1002 may map tokens of the input data 1010 to a set of embeddings 1016, for example, in the form of one or more embedding vectors. The embedding layer 1002 may be or include one or more neural networks and/or one or more machine learning models, such as the ANN 700 of FIG. 7. As an example, the embedding layer 1002 may be or include a pre-trained neural network that functions as a lookup table or dictionary. The embedding layer 1002 may map integer indices, which represent words or tokens (of the input data 1010), to dense vectors, or embeddings (e.g., numerical representations of the tokens) in an embedding space. An embedding may indicate the meaning of a token and/or the relationship of the token among the dictionary or vocabulary of tokens. For example, the set of embeddings 1016 may indicate the relationships among different information fed to the embedding layer 1002, such as different wireless link activities, channel conditions, wireless signaling, TDD frame pattern, HARQ feedback behaviors, or the like represented by the tokens. The weights of the embedding layer 1002 may be adjusted, for example, through a backpropagation pass during training.

The embedding vector (for example, the set of embeddings 1016) may be fed or provided to the language model 1004 to generate a probability distribution of next predicted token(s) (e.g., p(yt|yt−1, yt−2 . . . )). The probability distribution may be over a wireless language vocabulary at a time instant t conditioned on the previously predicted token(s) (e.g., before time t). The language model 1004 may include a deep learning language model, a generative transformer model, a large language model (LLM), a decoder-only autoregressive model, a decoder-only transformer model, a neural network (such as the ANN 700 of FIG. 7), and/or the like. In certain cases, the language model 1004 may receive embeddings 1016 and add positional encodings to the embeddings 1016 to provide information about the order of tokens in the original input sequence of tokens. The embeddings 1016 may then be passed into a multi-head masked self-attention mechanism that computes attention scores between each token and earlier tokens in the input sequence, but not future tokens in order to preserve causality. For instance, the attention score between two tokens measures the relevance or importance of one token to the other-if a first token has a high attention score with a second token, it means the first token heavily depends on or is influenced by the second token.

The language model 1004 may comprise a fully-connected feed forward layer that applies nonlinear transformations and refines the representation of the input sequence of tokens. The language model 1004 may further comprise a normalization layer and/or residual connections to stabilize the output from the feed-forward layer and improve gradient flow during training.

In some aspects, the language model 1004 may comprise multiple stacked layers, with each layer refining the token representations through repeated attention and feed-forward processing. The output of the last decoder layer of the language model 1004 may be passed through a linear layer (or a projection layer) that maps the output to the vocabulary size, e.g., the wireless protocol vocabulary. A softmax function may then be applied to determine a probability distribution (“the output distribution”) for the next token. As a part of inference, the pre-trained language model 1004 may generate the predicted probability distribution over the wireless vocabulary that indicates a realistic future downlink grant predictions for a subsequent period of time, such as specific number of transmission time intervals, slots, or the like.

The language model 1004 may autoregressively predict one or more next token(s). The output distribution may be fed or provided to the sampling layer 1006. The sampling layer 1006 may include one or more neural networks (such as the ANN 700 of FIG. 7). The sampling layer 1006 may sample a predicted next token from the vocabulary of wireless protocol language according to the output distribution. The sampling layer 1006 may apply any of various sampling techniques including, for example, greedy sampling, stochastic sampling, stochastic sampling based on a softmax temperature, and/or the like. The sampled next token is in turn appended to the input fed to the language model 1004. The language model 1004 thus regressively outputs a conditional distribution again in response to the input combining the predicted token in the preceding time step. In this way, the language model 1004 may effectively generate a series or sequence of predicted tokens, which may indicate one or more predictions over a future time window 1020. The resulting sequence of predicted output tokens may indicate predicted wireless communication activity, such as downlink grant prediction(s).

The output distribution of the language model 1004 may indicate one or more downlink grant predictions over the future time window 1020. As an example, the prediction(s) may enable a UE to determine whether to adjust the time spent in a sleep state or monitoring for downlink signaling associated with a DRX cycle. As another example, the prediction(s) may enable a network node to determine DRX cycle configurations for a group of UEs that have similar traffic patterns. In certain cases, the output distribution of the language model 1004 may correspond to predicted information that is not otherwise signaled to the UE and/or the network node.

The output distribution(s) may be fed or provided to the task-specific head 1008 to process and convert the output distribution(s) into output data 1018. The task-specific head 1008 may be or include one or more neural networks (such as the ANN 700 of FIG. 7). The task-specific head 1008 may be a modular neural network (such as a multi-layer perceptron (MLP)) used to interpret the output distribution(s) of the language model 1004 to a specific task, such as downlink grant prediction and/or any other suitable task (e.g., DRX cycle management). In certain cases, the task-specific head 1008 may be integrated into a transformer block of the language model 1004. In certain cases, the task-specific head 1008 may be part of a decoder layer of the language model 1004.

The generative AI language model 1000 may generate output data 1018 based on the input data 1010. For example, the task-specific head 1008 may output the output data 1018, which may include an indication of one or more downlink grant predictions, for example, over a future time window 1020 (such as 16 slots, 32 slots, 64 slots, 128 slots, 256 slots, 512 slots, or the like). The output data 1018 may be output directly from the generative AI language model 1000 (e.g., via the task-specific head 1008). In certain aspects, the output data 1018 may be derived from the autoregressive output of the generative AI language model 1000 (e.g., the output distributions). Accordingly, the generative AI language model 1000 may predict the wireless communication activity expected to occur in the future time window 1020 (for example, as in which device communications a particular signal and when). The generative AI language model 1000 may detect arbitrary scenarios and generate predictions of future wireless communication activity between a UE and a network node.

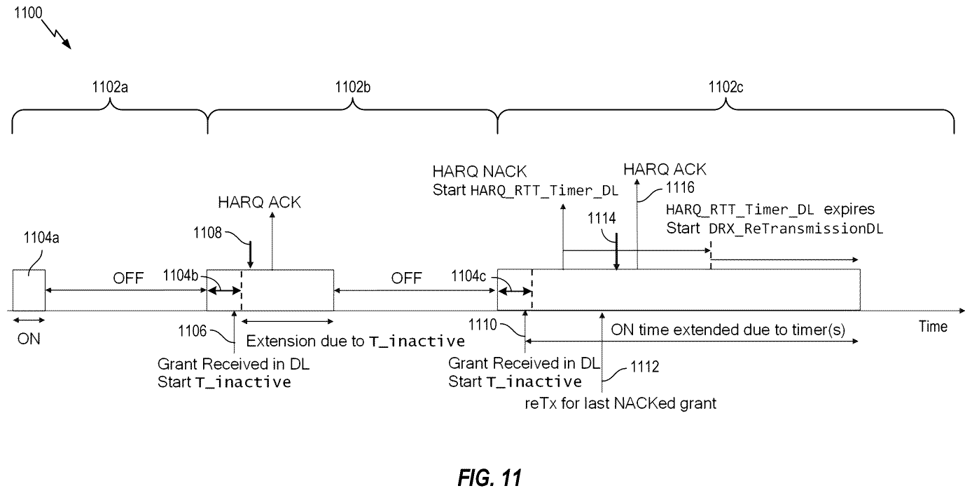

In certain cases, a prediction of the downlink grant prediction(s) is based at least in part on a probability associated with the prediction satisfying a threshold. As an example, if the prediction has a probability greater than or equal to the threshold, the associated event (e.g., a downlink transmission) may be treated as being expected to occur in a respective transmission time interval or slot. If the prediction has a probability less than the threshold, the associated event (e.g., the downlink transmission) may be treated as not being expected to occur in the respective transmission time interval or slot. Based on the threshold (Rxₜₕᵣₑₛₕ), if the generative AI language model 1000 predicts that there is no downlink grant in the next K slots, the UE can decide to go to sleep early (e.g., ending the inactivity timer early) resulting in power savings, as further described herein with respect to FIG. 11.

The output data 1018 may indicate or include a downlink grant prediction (whether a downlink grant is expected) for each transmission time interval or slot over (or within) the future time window 1020. The downlink grant predictions may be predicted on a slot by slot basis over the future time window 1020. In certain aspects, the duration of the future time window 1020 may be based at least in part on at least one timer associated with a DRX cycle. For example, the future time window 1020 may have a duration that can span the duration of any of the timers used to determine the inactive time period and/or active time period of the DRX cycle, for example, as described herein with respect to FIGS. 8 and 9.

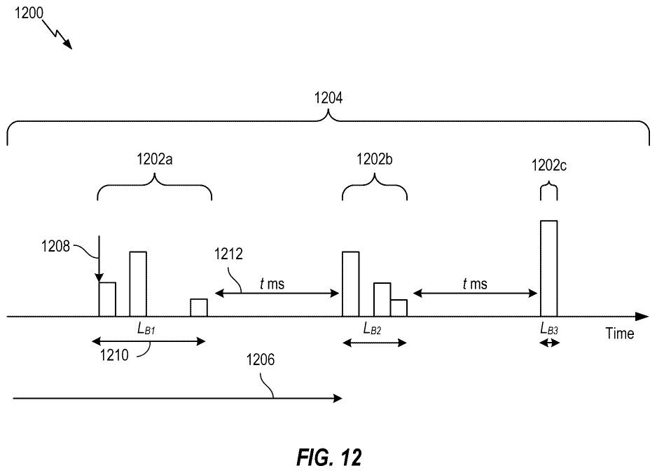

In certain aspects, the downlink grant prediction(s) may include a probability of arrival of one or more downlink grants (e.g., including a burst of downlink grants as further described herein with respect to FIG. 12) within a future time window 1020. A downlink grant may include downlink scheduling (e.g., DCI transmission(s)) that allocates communication resource(s) for one or more downlink transmissions. In certain cases, the downlink grant may include the downlink transmission(s) scheduled by the downlink scheduling and/or any retransmissions associated with the downlink transmission(s). In certain aspects, the downlink grant prediction(s) may include a probability of one or more retransmissions, associated with the downlink grant(s), within the future time window. The downlink grant prediction(s) may include a probability of a BLER, associated with the downlink grant(s), within the future time window 1020. In certain cases, the downlink grant prediction(s) may be used to derive an expected throughput, latency, and/or the like. For example, the downlink grant prediction(s) may indicate the expected throughput, latency, and/or the like.

The downlink grant prediction(s) may include one or more parameters associated with the downlink grant(s). The parameter(s) may include an arrival time of the downlink grant(s) (e.g., “the burst arrival time” as further described herein with respect to FIG. 12) and/or any derived quantities. In certain cases, the arrival time may be the time at which a downlink transmission is expected to be received at the UE for downlink reception. In certain cases, the arrival time may be the time at which a downlink payload is expected to be obtained or generated at a network node for downlink transmission (e.g., of user plane traffic and/or control plane traffic). The parameter(s) may include a duration of time in which the downlink grant(s) are predicted to arrive at the UE or the network node (e.g., “the burst duration” or “the burst length” as further described herein with respect to FIG. 12). The parameter(s) may include transmission configuration parameter(s), such as an MCS, code rate, rank (or a total number of MIMO layers), a data size (e.g., grant size, transport block size, payload size, or the like) of a transmission, a time-frequency resource allocation (e.g., the location and/or number of time-frequency resources), and/or the like. The time-frequency resource allocation may include the frequency allocation such as the number of resource elements allocated for a transmission.

During model training, the output distribution generated by the language model may be used to compute a training loss, for example, by comparing output distribution with a ground-truth token sequence—for example, actual or simulated downlink grant information from a training dataset. The training loss may comprise any of a cross-entropy loss, an L-2 norm loss, a mean square error loss, or the like. Parameter or weights of the language model 1004, the embedding layer 1002, the sampling layer 1006, and/or the task-specific head 1008 may then be updated via a backpropagation path by reducing (e.g., minimizing) the training loss. In certain aspects, the generative AI language model 1000 may be trained as described herein with respect to FIG. 7. The generative AI language model 1000 may be pre-trained based at least in part on training data that includes one or more training tokens associated with a wireless communication protocol. The training token(s) may be the tokenized form of the training data. As discussed, a token may indicate the characteristic(s) associated with a communication link between a UE and a network node, such the downlink rank, MCS, BLER, and/or the like. A training token may be a token derived from a training dataset.

As an example, the training data may include any of information associated with the input data 1010 described herein (or vice versa). The training data may include wireless communication data such as wireless configuration data applied at a UE and/or a network node. The training data may include interaction data that represents link, protocol, or traffic level data between the UE and wireless node in a sequence of tokens. Each training sample may correspond to link activity in a particular transmission time interval (e.g., a slot) in a communication scenario. The slot-based link activity may include a CSI report, downlink grant information, UE HARQ feedback (e.g., including ACK/NACK activity), a request to schedule grants, downlink rank (or MIMO layers), downlink MCS, an indication that there is no activity (e.g., when a UE is in an idle or inactive mode), etc. The training data may be or include historical wireless communication data of actual communications encountered between one or more UEs and one or more network nodes. In certain cases, the training data may be or include simulated and/or synthetic communication data from simulation of wireless communications between one or more UEs and one or more network nodes.

All such link, protocol, or traffic level wireless communication data (e.g., an input prompt or training data) may be tokenized, e.g., using one or more tokens or words to represent the wireless communication data. For example, during a slot, the UE may receive a downlink grant or send a CSI report, and such activities may be represented as tokens. Special token(s) may be used to indicate the beginning of a slot, the end of a slot, the beginning of a sequence, settings or configurations, or any other data that may not be signaled explicitly, and/or the like.

In certain cases, a UE may communicate with a network node based on the sequence of predicted output tokens in the future time window 1020. As an example, the output data 1018 may indicate the BLER or expected downlink transmission activity (including retransmission activity) in the future time window 1020. The UE may extend the inactive time period of a DRX cycle based on downlink grant predictions indicating that there are no downlink transmissions expected to be received during a configured active time period of the DRX cycle, for example, as further described herein with respect to FIG. 11. Accordingly, the generative AI model may enable the UE to reduce its power consumption by residing in a sleep state longer than a configured DRX cycle.

In certain cases, the network node may communicate with one or more UEs based on the sequence of predicted output tokens in the future time window 1020. In certain cases, the output data 1018 may enable the network node to configure the UE(s) to satisfy certain performance and/or power consumption specification(s) or goal(s), for example, based on predicted traffic patterns of the UE(s) indicated by the output data 1018. The input prompt (e.g., the input data 1010) may include wireless communication protocol data that indicates or includes hypothetical or future data or past performance data. In certain cases, the settings and/or goals of the network node may be included as tokens (e.g., expressed as tokens in the language of the wireless communication protocol data). This may allow the network node to prompt the generative AI language model 1000 with potentially competing goals or settings, and the network node may determine how to configure the UE(s) based on the output data 1018 for each prompted scenario and any other knowledge or information available to the network node. As an example, the output data 1018 may indicate that a set of UEs experience similar downlink traffic patterns (for example, the downlink traffic of the set of UEs may be predicted to occur in the same transmission time intervals or adjacent transmission time intervals over the future time window 1020), and thus, the network node may configure the set of UEs with generally the same or similar communication parameters, such as the same DRX cycle. As an example, the network node may configure the set of UEs to be in the same scheduling group, such that the set of UEs may be awake during the same on durations of the DRX cycle, during which predicted downlink traffic is expected to be communicated. Such UE configurations may enable the network node to allocate communication resources to other communications. Accordingly, the generative AI model may enable the network node to apply improved channel usage by configuring UEs with similar traffic patterns to use the same or similar communication parameters, such as the DRX cycle configuration.

FIG. 11 depicts an example scheme 1100 of applying language model-based downlink grant predictions to DRX cycle management. In this example, a UE may be configured with a DRX cycle, for example, as described herein with respect to FIGS. 8 and 9.

At a first instance 1102a of the DRX cycle, the UE may be configured to monitor for downlink signaling during a scheduled on duration 1104a, for example, as described herein with respect to FIG. 8. In certain cases, the downlink grant prediction(s) generated by a generative AI language model (such as the model 1000 of FIG. 10) may indicate that there are no downlink transmissions expected to be received in the respective active time period of the on duration 1104a. Thus, the UE may determine to remain in a sleep state without monitoring for any downlink signaling to reduce the UE's power consumption.

At a second instance 1102b of the DRX cycle, the UE may receive a downlink grant 1106, which may trigger the UE to start the inactivity timer (e.g., T_inactive), in the next on duration 1104b of the DRX cycle. The inactivity timer may be started at the end of the on duration 1104b to extend the active time period of the DRX cycle. The downlink grant 1106 may schedule the UE to receive downlink transmission(s). In certain cases, the downlink grant prediction(s) generated by the generative AI language model may indicate that the downlink transmission(s) are expected to end at a specific time 1108 (for example, based on a predicted transmission burst duration as further described herein with respect FIG. 12). The generative AI language model may predict that the transmission burst ends before the inactivity timer is expected to expire, and thus, the UE may determine to enter the sleep state early with respect to the configured duration of the inactivity timer. The UE may end the inactivity timer early and enter the sleep state to reduce the UE's power consumption. The UE may effectively reduce the duration of the active time period and increase the duration of the inactive time period based at least in part on the grant prediction(s) indicating that a transmission is not expected to arrive during a hypothetical duration of the active time period derived from at least one timer (e.g., the inactivity timer).

At a third instance 1102c of the DRX cycle, the UE may receive a downlink grant 1110, which may trigger the UE to start the inactivity timer, in the next on duration 1104c of the DRX cycle. The inactivity timer may be started at the end of the on duration 1104c to extend the active time period of the DRX cycle. Due to the UE not being able to successfully decode the scheduled transmission, the UE may send a HARQ NACK message to request a retransmission (not shown), which may trigger the UE to start the downlink HARQ RTT timer (e.g., HARQ_RTT_Timer_DL) and afterward the downlink HARQ retransmission timer (e.g., DRX_ReTransmsisionDL). The UE may receive a retransmission burst 1112 in response to the NACK. In certain cases, the downlink grant prediction(s) generated by the generative AI language model may indicate that the retransmission burst 1112 is expected to end at a specific time 1114 (for example, as further described herein with respect to FIG. 12). Thus, the UE may determine to end the downlink HARQ RTT timer early (and not start the downlink HARQ retransmission timer) and enter the sleep state to reduce the UE's power consumption. In certain cases, the UE may send a HARQ ACK 1116 to indicate that the retransmission burst 1112 was successfully received and decoded at the UE.

In certain cases, the downlink grant prediction(s) generated by a generative AI language model may indicate that predicted BLER for the retransmissions is above a threshold BLER. Thus, the UE may determine to refrain from monitoring for the retransmissions. This may trigger the network node to reschedule the retransmissions with enhanced coverage (e.g., redundancy) and improve the BLER.

Note that the instances of the DRX cycle depicted in FIG. 11 are example scenarios to facilitate an understanding of DRX cycle management, which may be enabled through language model-based downlink grant predictions. Aspects of the present disclosure may be applied to other DRX cycle scenarios, such as predicting the occurrence of downlink transmission to enhance the reliability of receiving downlink signaling.

FIG. 12 depicts an example scheme 1200 of predicting transmission burst(s) based on downlink grant prediction(s). In this example, a generative AI language model (such as the model 1000 of FIG. 10) may predict certain characteristic(s) associated with one or more transmission bursts 1202a-c in a time window 1204 (e.g., the future time window 1020 of FIG. 10). In certain aspects, the time window 1204 may correspond to a window length of predicted tokens generated by the generative AI language model, such as a window length of 512 tokens. In certain aspects, a context length 1206 of the generative AI language model may be based on the length of the time window and shift over the time window, for example, through autoregressive inference. The context length may be a portion of the time window.

The predicted characteristic(s) associated with a transmission burst (e.g., 1202a) may include burst arrival time 1208, a burst length 1210 or duration (e.g., L_{B1}, L_{B2}, and L_{B3}), a burst size (e.g., the total data or payload size of the transmission burst), a burst data rate, and/or the like. The predicted characteristic(s) may include the total number of transmission bursts 1202a-c within the future time window 1204. The burst size may be defined in terms of bits and/or time-frequency resource allocation. The burst length 1210 may be defined in terms of a total number of slots.

In certain cases, adjacent transmission bursts (e.g., 1202a, 1202b) may be separated in time by a burst interval 1212 having a specific duration (e.g., t ms). The burst interval 1212 may be due to a transmission periodicity, for example, associated with periodic downlink traffic, such as extended reality traffic, voice traffic, video traffic, gaming traffic, and/or the like. The burst interval 1212 may be due to a configured DRX cycle. The burst interval may be a predicted characteristic and/or a static parameter of the generative AI language model. In certain aspects, the burst interval may be the separation time expected to occur between adjacent transmission bursts. The burst interval 1212 may be defined in terms of a number of slots, such as 16 slots.

Accordingly, based on the downlink grant predictions, the UE may determine when to enter or remain in a sleep state to reduce power consumption and/or prepare for downlink communications to enhance the reliability of downlink communications. As an example, the UE may effectively shorten (e.g., not start or end early) certain timer(s) that determine the duration of the inactive time period and the active time period, such as the DRX inactivity timer, the downlink HARQ RTT timer and/or the downlink HARQ retransmission timer, as described herein with respect to FIGS. 8 and 9. In certain cases, the timer(s) of the DRX cycle may be adjusted based on a BLER prediction associated with the downlink grant predictions described herein. For example, the predicted BLER of a transmission or a retransmission may be factored in deciding whether to remain in a sleep state or transition to a sleep state. As an example, if the predicted BLER of a retransmission (e.g., ReTxBLER) is greater than a BLER threshold (e.g., BLERThresh), such a prediction may indicate that there is a high probability of a retransmission occurring, and the UE can decide to transition to a sleep state.

In certain aspects, the network node may determine certain parameters associated with the DRX cycle based on the downlink grant prediction(s), such as the DRX cycle periodicity, the time offset of the DRX cycle, and/or duration of certain timer(s) described herein. As an example, the network node may configure multiple UEs with the same DRX configuration based on the downlink grant prediction(s) indicating that the UEs may experience similar downlink traffic patterns (e.g., downlink transmissions with the same periodicity). Such DRX cycle alignment (for example, in terms of time-frequency resource allocations for an on duration and/or an off duration) may improve the channel usage to reallocate communication resources for other traffic or communications. As another example, the network node may configure a UE with a DRX configuration based on the downlink grant prediction(s) indicating the downlink traffic pattern of the UE. Thus, grant prediction(s) may enable the network node to configure a DRX cycle that aligns with the predicted traffic pattern associated with a UE, which in turn may allow the network node to allocate or use communication resources for other communications.

### Example Signaling of Language Model-Based Downlink Grant Prediction

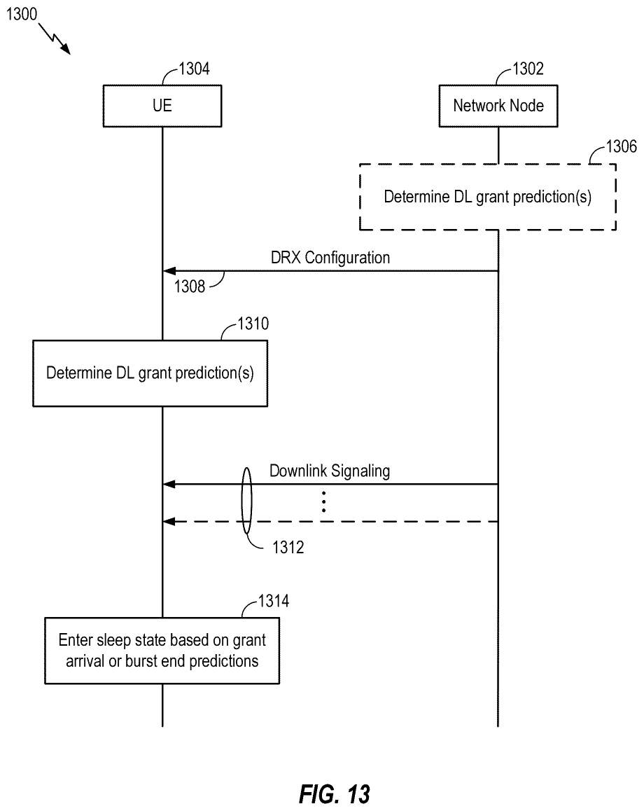

FIG. 13 depicts a process flow 1300 for language model-based downlink grant prediction in a system between a network node 1302 and a user equipment (UE) 1304. In some aspects, the network node 1302 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 1304 may be an example of UE 104 depicted and described with respect to FIG. 1 or the UE 304 depicted and described with respect to FIG. 3. However, in other aspects, UE 1304 may be another type of wireless communications device, and network node 1302 may be another type of network entity or network node, such as those described herein. Note that any operations or signaling illustrated with dashed lines may indicate that that operation or signaling is an optional or alternative example.

At 1306, the network node 1302 optionally determines one or more downlink grant predictions using a generative AI language model, for example, as described herein with respect to FIG. 10. In certain cases, the downlink grant prediction(s) may indicate the downlink traffic pattern associated with the UE 1304.

At 1308, the UE 1304 obtains, from the network node 1302, a DRX configuration, for example, as described herein with respect to FIGS. 8 and 9. The DRX configuration may indicate or include one or more durations for on duration timer, an inactivity timer, a downlink HARQ RTT timer, a downlink HARQ retransmission timer, or the like. As an example, the DRX configuration may indicate or include one or more parameters as described herein with respect to FIGS. 8 and 9, such as DRX-onDurationTimer, drx-HARQ-RTT-Timer (DL or UL), drx-RetransmissionTimer (DL or UL), drx-ShortCycleTimer, drx-ShortCycle, drx-LongCycleStartOffset, drx-SlotOffset, drx-InactivityTimer, or the like. In certain cases, the network node 1302 may generate or determine the DRX configuration independent of the downlink grant prediction(s) determined at 1306. In certain cases, the network node 1302 may generate or determine the DRX configuration based on the downlink grant prediction(s) determined at 1306. As an example, the DRX configuration may be assigned to one or more UEs to enable improved channel usage, for example, based on the downlink grant prediction(s) indicating that the UE(s) experience similar traffic patterns or the like.

At 1310, the UE 1304 determines one or more downlink grant prediction(s) using a generative AI language model, for example, as described herein with respect to FIG. 10. The downlink grant prediction(s) may indicate that downlink traffic (if any) is expected to arrive in a future time window, for example, as described herein with respect to FIGS. 10-12. In certain cases, the downlink grant prediction(s) may indicate the expected BLER associated with downlink transmissions in the future time window.

At 1312, the UE 1304 obtains, from the network node 1302, downlink signaling, for example, during an on duration associated with the DRX cycle. In certain cases, the downlink grant prediction(s) may indicate the arrival time, duration, size, or the like of the downlink signaling. Such information may enable the UE 1304 to prepare certain circuitry (e.g., a transceiver and/or processor) to receive and process the downlink signaling with improved reliability.

At 1314, the UE 1304 enters a sleep state based at least in part on the downlink grant prediction(s), for example, as described herein with respect to FIGS. 10 and 11. In certain cases, the downlink grant prediction(s) may indicate the time at which the downlink signaling is expected to end (e.g., in terms of a grant arrival time and/or burst end prediction(s)). Based on the downlink grant prediction(s), the UE 1304 can enter a sleep state early, which may occur before the expiration of certain timer(s), for example, as described herein with respect to FIG. 11. In certain cases, the UE 1304 may enter the sleep state early even in cases where the DRX configuration is based on the downlink grant prediction(s) determined at 1306. Thus, the downlink grant prediction(s) may enable the UE 1304 to reduce power consumption by entering the sleep state. In certain cases, the network node 1302 may be aware of the UE 1304 entering the sleep state early based on the downlink grant prediction(s) (for example, determined at 1306), and the network node 1302 may reallocate communication resources configured for the DRX cycle, which may improve the channel usage.

Note that the process flow illustrated in FIG. 13 is an example of DRX cycle management based on downlink grant predictions, and aspects of the present disclosure may be applied to various other wireless communication scenarios using the downlink grant predictions described herein. Note that the process flow illustrated in FIG. 13 is described herein to facilitate an understanding of language model-based downlink grant prediction, and aspects of the present disclosure may be performed in various manners via alternative or additional signaling and/or operations. In certain aspects, the operations and/or signaling of FIG. 13 may occur in an order different from that described or depicted, and various actions, operations, and/or signaling may be added, omitted, or combined.

### Example Operations of Language Model-Based Downlink Grant Prediction

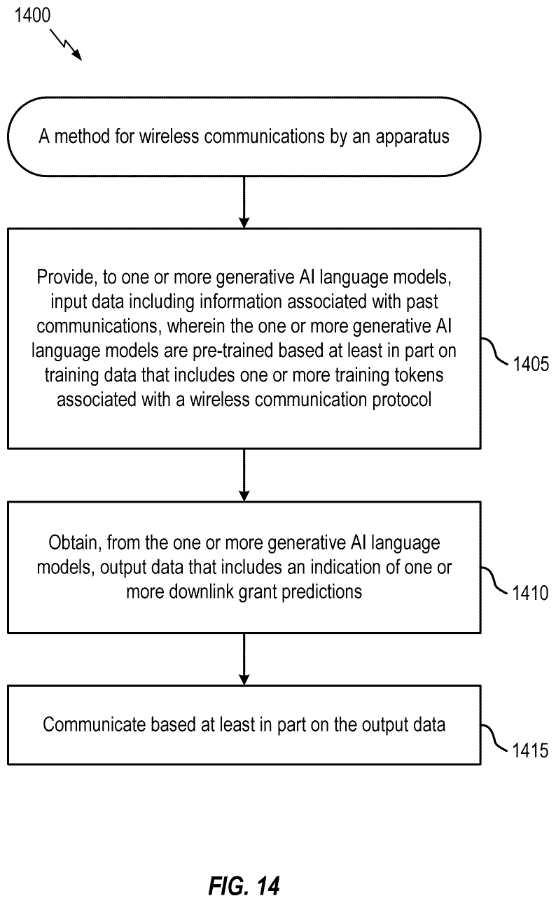

FIG. 14 shows a method 1400 for wireless communications by an apparatus, such as UE 104 of FIG. 1 or UE 304 of FIG. 3.

Method 1400 begins at block 1405 with providing, to one or more generative AI language models, input data including information associated with past communications, wherein the one or more generative AI language models are pre-trained based at least in part on training data that includes one or more training tokens associated with a wireless communication protocol, for example, as described herein with respect to FIGS. 10-13.

Method 1400 then proceeds to block 1410 with obtaining, from the one or more generative AI language models, output data that includes an indication of one or more downlink grant predictions, for example, as described herein with respect to FIGS. 10-13.

Method 1400 then proceeds to block 1415 with communicating based at least in part on the output data, for example, as described herein with respect to FIGS. 10-13.

In some aspects, block 1415 includes adjusting a duration of an inactive time period and a duration of an active time period of a DRX cycle based at least in part on the output data.

In some aspects, adjusting the duration of the inactive time period and the duration of the active time period comprises reducing the duration of the active time period and increasing the duration of the inactive time period based at least in part on the one or more downlink grant predictions indicating that a transmission is not expected to arrive during a hypothetical duration of the active time period derived from at least one timer.

In some aspects, the at least one timer comprises one or more of: a DRX inactivity timer, a HARQ round-trip timer, or a HARQ retransmission timer.

In some aspects, the one or more downlink grant predictions are based at least in part on a predicted block error rate exceeding a threshold block error rate.

In some aspects, the input data comprises at least one previous downlink grant prediction.

In some aspects, the information comprises one or more of: a downlink rank; a modulation and coding scheme; a frequency resource allocation; a time domain resource allocation; one or more channel state information reports; HARQ feedback; or one or more beams.

In some aspects, the one or more training tokens indicate one or more characteristics associated with a communication link between the UE and a network node.

In some aspects, at least one token of the one or more training tokens indicates a set of characteristics associated with a transmission time interval.

In some aspects, the one or more downlink grant predictions comprise one or more of: a probability of arrival of one or more downlink grants within a future time window; one or more parameters associated with the one or more downlink grants; a probability of one or more retransmissions, associated with the one or more downlink grants, within the future time window; or a probability of a block error rate, associated with the one or more downlink grants, within the future time window.

In some aspects, the one or more parameters comprises one or more of: an arrival time of the one or more downlink grants; a duration of time in which the one or more downlink grants are predicted to arrive; a modulation and coding scheme; a rank; a data size of a transmission; or a time-frequency resource allocation.

In some aspects, a duration of the future time window is based at least in part on at least one timer associated with a DRX cycle.

In some aspects, the one or more generative AI language models comprise one or more of a generative transformer model, a large language model, an autoregressive model, or a neural network.

In some aspects, the one or more generative AI language models comprise one or more of an embedding layer, a generative language model, a neural network layer, or a sampling layer.

In some aspects, a prediction of the one or more downlink grant predictions is based at least in part on a probability associated with the prediction satisfying a threshold.

In some aspects, method 1400 further includes communicating an indication of one or more thresholds associated with the one or more downlink grant predictions.

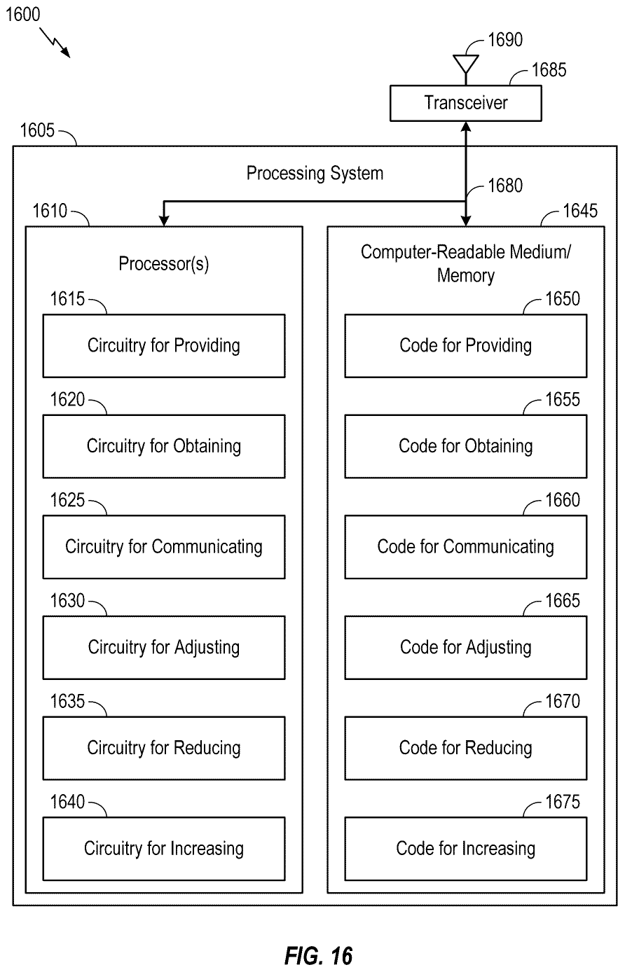

In some aspects, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative operations are possible consistent with this disclosure.

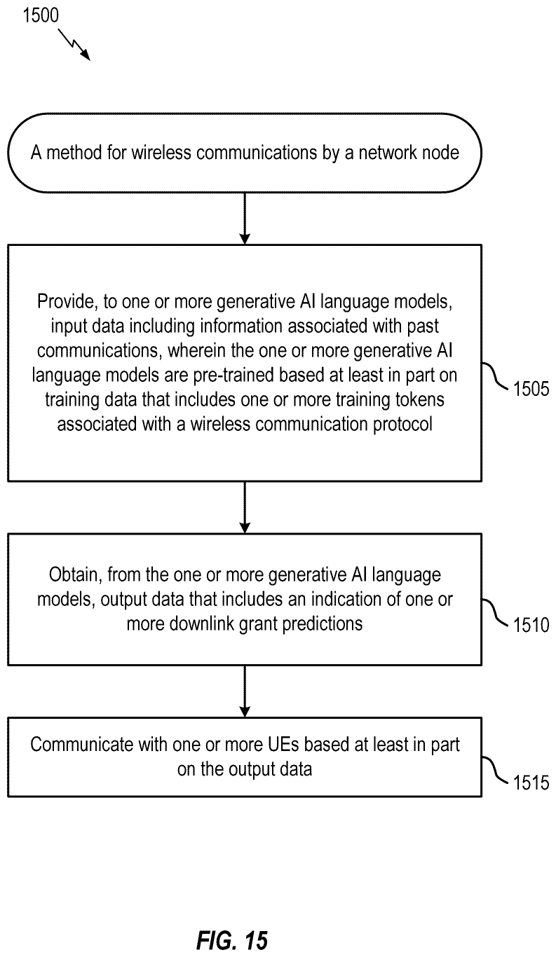

FIG. 15 shows a method 1500 for wireless communications by an apparatus, such as BS 102 of FIG. 1, a first network entity 300 or second network entity 302 of FIG. 3, or a disaggregated base station as discussed with respect to FIG. 2.

Method 1500 begins at block 1505 with providing, to one or more generative AI language models, input data including information associated with past communications, wherein the one or more generative AI language models are pre-trained based at least in part on training data that includes one or more training tokens associated with a wireless communication protocol, for example, as described herein with respect to FIGS. 10-13.

Method 1500 then proceeds to block 1510 with obtaining, from the one or more generative AI language models, output data that includes an indication of one or more downlink grant predictions, for example, as described herein with respect to FIGS. 10-13.

Method 1500 then proceeds to block 1515 with communicating with one or more UEs based at least in part on the output data, for example, as described herein with respect to FIGS. 10-13.

In some aspects, block 1515 includes: sending, to the one or more UEs, a DRX cycle configuration based at least in part on the output data; and communicating with at least one of the one or more UEs during an active time period of a DRX cycle associated with the DRX cycle configuration.

In some aspects, the one or more UEs comprises a plurality of UEs; the output data indicates a future traffic pattern associated with the one or more UEs; and the DRX cycle configuration indicates one or more time-frequency resource allocations for the active time period of the DRX cycle in accordance with the future traffic pattern.

In some aspects, the active time period coincides with at least one downlink transmission of the future traffic pattern.

In some aspects, the input data comprises at least one previous downlink grant prediction.

In some aspects, the information comprises one or more of: a downlink rank; a modulation and coding scheme; a frequency resource allocation; a time domain resource allocation; one or more channel state information reports; HARQ feedback; or one or more beams.

In some aspects, the one or more training tokens indicate one or more characteristics associated with a communication link between a UE and the network node.

In some aspects, at least token of the one or more training tokens indicates a set of characteristics associated with a transmission time interval.

In some aspects, the one or more downlink grant predictions comprise one or more of: a probability of arrival of one or more downlink grants within a future time window; one or more parameters associated with the one or more downlink grants; a probability of one or more retransmissions, associated with the one or more downlink grants, within the future time window; or a probability of a block error rate, associated with the one or more downlink grants, within the future time window.

In some aspects, the one or more parameters comprises one or more of: an arrival time of the one or more downlink grants; a duration of time in which the one or more downlink grants are predicted to arrive; a modulation and coding scheme; a rank; a data size of a transmission; or a time-frequency resource allocation.

In some aspects, a duration of the future time window is based at least in part on at least one timer associated with a DRX cycle.

In some aspects, the one or more generative AI language models comprise one or more of a generative transformer model, a large language model, an autoregressive model, or a neural network.

In some aspects, the one or more generative AI language models comprise one or more of an embedding layer, a generative language model, a neural network layer, or a sampling layer.

In some aspects, a prediction of the one or more downlink grant predictions is based at least in part on a probability associated with the prediction satisfying a threshold.

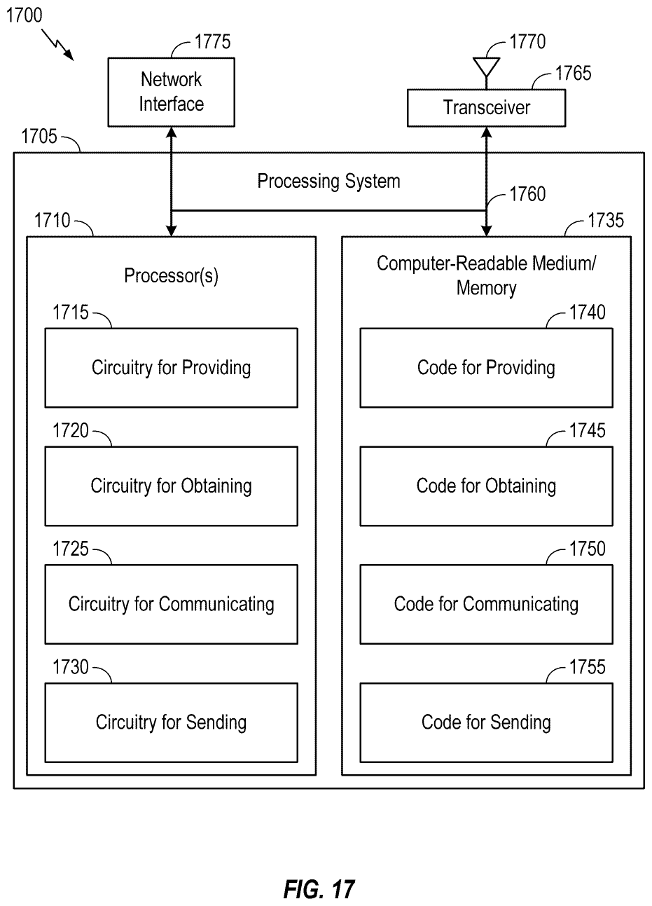

In some aspects, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative operations are possible consistent with this disclosure.

### Example Communications Devices

FIG. 16 depicts aspects of an example communications device 1600 configured for wireless communications. In some aspects, communications device 1600 is a user equipment, such as UE 104 described above with respect to FIG. 1 or UE 304 described with respect to FIG. 3.

The communications device 1600 includes a processing system 1605 coupled to a transceiver 1685 (e.g., a transmitter and/or a receiver). The transceiver 1685 is configured to transmit and receive signals for the communications device 1600 via an antenna 1690, such as the various signals as described herein. The processing system 1605 may be configured to perform processing functions for the communications device 1600, including processing signals received and/or to be transmitted by the communications device 1600.

The processing system 1605 includes one or more processors 1610 and a computer-readable medium/memory 1645. In various aspects, the one or more processors 1610 may be representative of the one or more processors 318 described with respect to FIG. 3. The one or more processors 1610 are coupled to a computer-readable medium/memory 1645 via a bus 1680. In some aspects, the computer-readable medium/memory 1645 may be representative of the one or more memories 320 described with respect to FIG. 3. The computer-readable medium/memory 1645 is a non-transitory computer-readable medium/memory. In certain aspects, the computer-readable medium/memory 1645 is configured to store instructions (e.g., computer-executable code), that when executed by the one or more processors 1610, cause the one or more processors 1610 to perform the method 1400 described with respect to FIG. 14, or any aspect related to it, including any operations described in relation to FIG. 14. Note that reference to a processor performing a function of communications device 1600 may include one or more processors performing that function of communications device 1600, such as in a distributed fashion.

In the depicted example, computer-readable medium/memory 1645 stores code (e.g., executable instructions), including code for providing 1650, code for obtaining 1655, code for communicating 1660, code for adjusting 1665, code for reducing 1670, and code for increasing 1675. Processing of the code 1650-1675 may enable and cause the communications device 1600 to perform the method 1400 described with respect to FIG. 14, or any aspect related to it. For instance, in some aspects, code for providing 1650 includes code for providing, to one or more generative AI language models, input data including information associated with past communications, wherein the one or more generative AI language models are pre-trained based at least in part on training data that includes one or more training tokens associated with a wireless communication protocol. In some aspects, code for obtaining 1655 includes code for obtaining, from the one or more generative AI language models, output data that includes an indication of one or more downlink grant predictions. In some aspects, code for communicating 1660 includes code for communicating based at least in part on the output data.

The one or more processors 1610 include circuitry configured to implement (e.g., execute) the code stored in the computer-readable medium/memory 1645, including circuitry for providing 1615, circuitry for obtaining 1620, circuitry for communicating 1625, circuitry for adjusting 1630, circuitry for reducing 1635, and circuitry for increasing 1640. Processing with circuitry 1615-1640 may enable and cause the communications device 1600 to perform the method 1400 described with respect to FIG. 14, or any aspect related to it. For instance, in some aspects, circuitry for providing 1615 includes circuitry for providing, to one or more generative AI language models, input data including information associated with past communications, wherein the one or more generative AI language models are pre-trained based at least in part on training data that includes one or more training tokens associated with a wireless communication protocol. In some aspects, circuitry for obtaining 1620 includes circuitry for obtaining, from the one or more generative AI language models, output data that includes an indication of one or more downlink grant predictions. In some aspects, circuitry for communicating 1625 includes circuitry for communicating based at least in part on the output data.

More generally, means for communicating, transmitting, sending or outputting for transmission may include the one or more transceivers 324, one or more antenna 322 and/or processing system 316 of the UE 304 illustrated in FIG. 3, transceiver 1685 and/or antenna 1690 of the communications device 1600 in FIG. 16, and/or one or more processors 1610 of the communications device 1600 in FIG. 16. Means for communicating, receiving or obtaining may include the one or more transceivers 324, one or more antennas 322, and/or processing system 316 of the UE 304 illustrated in FIG. 3, transceiver 1685 and/or antenna 1690 of the communications device 1600 in FIG. 16, and/or one or more processors 1610 of the communications device 1600 in FIG. 16. Means for adjusting, means for reducing, and/or means for increasing may include the processing system 316 of the UE 304 illustrated in FIG. 3, and/or one or more processors 1610 of the communications device 1600 in FIG. 16.

FIG. 17 depicts aspects of an example communications device configured for wireless communications. In some aspects, communications device 1700 is a network entity, such as BS 102 of FIG. 1, first network entity 300 or second network entity 302 of FIG. 3, or a disaggregated base station as discussed with respect to FIG. 2.

The communications device 1700 includes a processing system 1705 coupled to a transceiver 1765 (e.g., a transmitter and/or a receiver) and/or a network interface 1775. The transceiver 1765 is configured to transmit and receive signals for the communications device 1700 via an antenna 1770, such as the various signals as described herein. The network interface 1775 is configured to obtain and send signals for the communications device 1700 via communications link(s), such as a backhaul link, midhaul link, and/or fronthaul link as described herein, such as with respect to FIG. 2. The processing system 1705 may be configured to perform processing functions for the communications device 1700, including processing signals received and/or to be transmitted by the communications device 1700.

The processing system 1705 includes one or more processors 1710 and a computer-readable medium/memory 1735. In various aspects, one or more processors 1710 may be representative of the one or more processors 308, as described with respect to FIG. 3. The one or more processors 1710 are coupled to the computer-readable medium/memory 1735 via a bus 1760. In certain aspects, the computer-readable medium/memory 1735 is configured to store instructions (e.g., computer-executable code), including code 1740-1755, that when executed by the one or more processors 1710, cause the one or more processors 1710 to perform the method 1500 described with respect to FIG. 15, or any aspect related to it, including any operations described in relation to FIG. 15. The computer-readable medium/memory 1735 is a non-transitory computer-readable medium/memory. Note that reference to a processor of communications device 1700 performing a function may include one or more processors of communications device 1700 performing that function, such as in a distributed fashion.

In the depicted example, the computer-readable medium/memory 1735 stores code (e.g., executable instructions), including code for providing 1740, code for obtaining 1745, code for communicating 1750, and code for sending 1755. Processing of the code 1740-1755 may enable and cause the communications device 1700 to perform the method 1500 described with respect to FIG. 15, or any aspect related to it. For instance, code for providing 1740 includes code for providing, to one or more generative AI language models, input data including information associated with past communications, wherein the one or more generative AI language models are pre-trained based at least in part on training data that includes one or more training tokens associated with a wireless communication protocol. In some aspects, code for obtaining 1745 includes code for obtaining, from the one or more generative AI language models, output data that includes an indication of one or more downlink grant predictions. In some aspects, code for communicating 1750 includes code for communicating with one or more UEs based at least in part on the output data.

The one or more processors 1710 include circuitry configured to implement (e.g., execute) the code stored in the computer-readable medium/memory 1735, including circuitry for providing 1715, circuitry for obtaining 1720, circuitry for communicating 1725, and circuitry for sending 1730. Processing with circuitry 1715-1730 may enable and cause the communications device 1700 to perform the method 1500 described with respect to FIG. 15, or any aspect related to it. For instance, circuitry for providing 1715 includes circuitry for providing, to one or more generative AI language models, input data including information associated with past communications, wherein the one or more generative AI language models are pre-trained based at least in part on training data that includes one or more training tokens associated with a wireless communication protocol. In some aspects, circuitry for obtaining 1720 includes circuitry for obtaining, from the one or more generative AI language models, output data that includes an indication of one or more downlink grant predictions. In some aspects, circuitry for communicating 1725 includes circuitry for communicating with one or more UEs based at least in part on the output data.

Various components of the communications device 1700 may provide means for performing the method 1500 described with respect to FIG. 15, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1765, antenna 1770, and/or network interface 1775 of the communications device 1700 in FIG. 17, and/or one or more processors 1710 of the communications device 1700 in FIG. 17. Means for communicating, receiving or obtaining may include the one or more transceivers 312, one or more antennas 314, and/or processing system 306 of the first network entity 300 or the second network entity 302 illustrated in FIG. 3, transceiver 1765, antenna 1770, and/or network interface 1775 of the communications device 1700 in FIG. 17, and/or one or more processors 1710 of the communications device 1700 in FIG. 17.

### Example Clauses

Implementation examples are described in the following numbered clauses:

Clause 1: A method for wireless communications by a UE comprising: providing, to one or more generative AI language models, input data including information associated with past communications, wherein the one or more generative AI language models are pre-trained based at least in part on training data that includes one or more training tokens associated with a wireless communication protocol; obtaining, from the one or more generative AI language models, output data that includes an indication of one or more downlink grant predictions; and communicating based at least in part on the output data.

Clause 2: The method of Clause 1, wherein communicating comprises adjusting a duration of an inactive time period and a duration of an active time period of a DRX cycle based at least in part on the output data.

Clause 3: The method of Clause 2, wherein adjusting the duration of the inactive time period and the duration of the active time period comprises reducing the duration of the active time period and increasing the duration of the inactive time period based at least in part on the one or more downlink grant predictions indicating that a transmission is not expected to arrive during a hypothetical duration of the active time period derived from at least one timer.

Clause 4: The method of Clause 3, wherein the at least one timer comprises one or more of: a DRX inactivity timer, a HARQ round-trip timer, or a HARQ retransmission timer.

Clause 5: The method of Clause 3 or 4, wherein the one or more downlink grant predictions are based at least in part on a predicted block error rate exceeding a threshold block error rate.

Clause 6: The method of any one of Clauses 1-5, wherein the input data comprises at least one previous downlink grant prediction.

Clause 7: The method of any one of Clauses 1-6, wherein the information comprises one or more of: a downlink rank; a modulation and coding scheme; a frequency resource allocation; a time domain resource allocation; one or more channel state information reports; HARQ feedback; or one or more beams.

Clause 8: The method of any one of Clauses 1-7, wherein the one or more training tokens indicate one or more characteristics associated with a communication link between the UE and a network node.

Clause 9: The method of Clause 8, wherein at least one token of the one or more training tokens indicates a set of characteristics associated with a transmission time interval.

Clause 10: The method of any one of Clauses 1-9, wherein the one or more downlink grant predictions comprise one or more of: a probability of arrival of one or more downlink grants within a future time window; one or more parameters associated with the one or more downlink grants; a probability of one or more retransmissions, associated with the one or more downlink grants, within the future time window; or a probability of a block error rate, associated with the one or more downlink grants, within the future time window.

Clause 11: The method of Clause 10, wherein the one or more parameters comprises one or more of: an arrival time of the one or more downlink grants; a duration of time in which the one or more downlink grants are predicted to arrive; a modulation and coding scheme; a rank; a data size of a transmission; or a time-frequency resource allocation.

Clause 12: The method of Clause 10 or 11, wherein a duration of the future time window is based at least in part on at least one timer associated with a DRX cycle.

Clause 13: The method of any one of Clauses 1-12, wherein the one or more generative AI language models comprise one or more of a generative transformer model, a large language model, an autoregressive model, or a neural network.

Clause 14: The method of any one of Clauses 1-13, wherein the one or more generative AI language models comprise one or more of an embedding layer, a generative language model, a neural network layer, or a sampling layer.

Clause 15: The method of any one of Clauses 1-14, wherein a prediction of the one or more downlink grant predictions is based at least in part on a probability associated with the prediction satisfying a threshold.

Clause 16: The method of any one of Clauses 1-15, further comprising communicating an indication of one or more thresholds associated with the one or more downlink grant predictions.

Clause 17: A method for wireless communications by a network node comprising: providing, to one or more generative AI language models, input data including information associated with past communications, wherein the one or more generative AI language models are pre-trained based at least in part on training data that includes one or more training tokens associated with a wireless communication protocol; obtaining, from the one or more generative AI language models, output data that includes an indication of one or more downlink grant predictions; and communicating with one or more UEs based at least in part on the output data.

Clause 18: The method of Clause 17, wherein communicating comprises: sending, to the one or more UEs, a DRX cycle configuration based at least in part on the output data; and communicating with at least one of the one or more UEs during an active time period of a DRX cycle associated with the DRX cycle configuration.

Clause 19: The method of Clause 18, wherein: the one or more UEs comprises a plurality of UEs; the output data indicates a future traffic pattern associated with the one or more UEs; and the DRX cycle configuration indicates one or more time-frequency resource allocations for the active time period of the DRX cycle in accordance with the future traffic pattern.

Clause 20: The method of Clause 19, wherein the active time period coincides with at least one downlink transmission of the future traffic pattern.

Clause 21: The method of any one of Clauses 17-20, wherein the input data comprises at least one previous downlink grant prediction.

Clause 22: The method of any one of Clauses 17-21, wherein the information comprises one or more of: a downlink rank; a modulation and coding scheme; a frequency resource allocation; a time domain resource allocation; one or more channel state information reports; HARQ feedback; or one or more beams.

Clause 23: The method of any one of Clauses 17-22, wherein the one or more training tokens indicate one or more characteristics associated with a communication link between a UE and the network node.

Clause 24: The method of Clause 23, wherein at least token of the one or more training tokens indicates a set of characteristics associated with a transmission time interval.

Clause 25: The method of any one of Clauses 17-24, wherein the one or more downlink grant predictions comprise one or more of: a probability of arrival of one or more downlink grants within a future time window; one or more parameters associated with the one or more downlink grants; a probability of one or more retransmissions, associated with the one or more downlink grants, within the future time window; or a probability of a block error rate, associated with the one or more downlink grants, within the future time window.

Clause 26: The method of Clause 25, wherein the one or more parameters comprises one or more of: an arrival time of the one or more downlink grants; a duration of time in which the one or more downlink grants are predicted to arrive; a modulation and coding scheme; a rank; a data size of a transmission; or a time-frequency resource allocation.

Clause 27: The method of Clause 25 or 26, wherein a duration of the future time window is based at least in part on at least one timer associated with a DRX cycle.

Clause 28: The method of any one of Clauses 17-27, wherein the one or more generative AI language models comprise one or more of a generative transformer model, a large language model, an autoregressive model, or a neural network.

Clause 29: The method of any one of Clauses 17-28, wherein the one or more generative AI language models comprise one or more of an embedding layer, a generative language model, a neural network layer, or a sampling layer.

Clause 30: The method of any one of Clauses 17-29, wherein a prediction of the one or more downlink grant predictions is based at least in part on a probability associated with the prediction satisfying a threshold.

Clause 31: One or more apparatuses, comprising: one or more memories comprising executable instructions; and one or more processors configured to execute the executable instructions and cause the one or more apparatuses to perform a method in accordance with any one of Clauses 1-30.

Clause 32: One or more apparatuses configured for wireless communications, comprising: one or more memories; and one or more processors, coupled to the one or more memories, configured to cause the one or more apparatuses to perform a method in accordance with any one of Clauses 1-30.

Clause 33: One or more apparatuses configured for wireless communications, comprising: one or more memories; and one or more processors, coupled to the one or more memories, configured to perform a method in accordance with any one of Clauses 1-30.

Clause 34: One or more apparatuses, comprising means for performing a method in accordance with any one of Clauses 1-30.

Clause 35: One or more non-transitory computer-readable media comprising executable instructions that, when executed by one or more processors of one or more apparatuses, cause the one or more apparatuses to perform a method in accordance with any one of Clauses 1-30.

Clause 36: One or more computer program products embodied on one or more computer-readable storage media comprising code for performing a method in accordance with any one of Clauses 1-30.

Clause 37: One or more apparatuses configured for wireless communications, comprising: a processing system that includes one or more processors and one or more memories coupled with the one or more processors, the processing system configured to cause the one or more apparatuses to perform a method in accordance with any one of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE):
provide, to one or more generative artificial intelligence (AI) language models, input data including information associated with past communications, wherein the one or more generative AI language models are pre-trained based at least in part on training data that includes one or more training tokens associated with a wireless communication protocol;
obtain, from the one or more generative AI language models, output data that includes an indication of one or more downlink grant predictions; and
communicate based at least in part on the output data.

2. The apparatus of claim 1, wherein to cause the UE to communicate, the processing system is configured to cause the UE to adjust a duration of an inactive time period and a duration of an active time period of a discontinuous reception (DRX) cycle based at least in part on the output data.

3. The apparatus of claim 2, wherein to cause the UE to adjust the duration of the inactive time period and the duration of the active time period, the processing system is configured to cause the UE to reduce the duration of the active time period and increase the duration of the inactive time period based at least in part on the one or more downlink grant predictions indicating that a transmission is not expected to arrive during a hypothetical duration of the active time period derived from at least one timer.

4. The apparatus of claim 3, wherein the at least one timer comprises one or more of:
a DRX inactivity timer,
a hybrid automatic repeat request (HARQ) round-trip timer, or
a HARQ retransmission timer.

5. The apparatus of claim 3, wherein the one or more downlink grant predictions are based at least in part on a predicted block error rate exceeding a threshold block error rate.

6. The apparatus of claim 1, wherein the input data comprises at least one previous downlink grant prediction.

7. The apparatus of claim 1, wherein the information comprises one or more of:
a downlink rank;
a modulation and coding scheme;
a frequency resource allocation;
a time domain resource allocation;
one or more channel state information reports;
hybrid automatic repeat request (HARQ) feedback; or
one or more beams.

8. The apparatus of claim 1, wherein the one or more training tokens indicate one or more characteristics associated with a communication link between the UE and a network node.

9. The apparatus of claim 8, wherein at least one token of the one or more training tokens indicates a set of characteristics associated with a transmission time interval.

10. The apparatus of claim 1, wherein the one or more downlink grant predictions comprise one or more of:
a probability of arrival of one or more downlink grants within a future time window;
one or more parameters associated with the one or more downlink grants;
a probability of one or more retransmissions, associated with the one or more downlink grants, within the future time window; or
a probability of a block error rate, associated with the one or more downlink grants, within the future time window.

11. The apparatus of claim 10, wherein the one or more parameters comprises one or more of:
an arrival time of the one or more downlink grants;
a duration of time in which the one or more downlink grants are predicted to arrive;
a modulation and coding scheme;
a rank;
a data size of a transmission; or
a time-frequency resource allocation.

12. The apparatus of claim 10, wherein a duration of the future time window is based at least in part on at least one timer associated with a discontinuous reception (DRX) cycle.

13. The apparatus of claim 1, wherein the one or more generative AI language models comprise one or more of a generative transformer model, a large language model, an autoregressive model, or a neural network.

14. The apparatus of claim 1, wherein the one or more generative AI language models comprise one or more of an embedding layer, a generative language model, a neural network layer, or a sampling layer.

15. The apparatus of claim 1, wherein a prediction of the one or more downlink grant predictions is based at least in part on a probability associated with the prediction satisfying a threshold.

16. The apparatus of claim 1, wherein the processing system is configured to cause the UE to communicate an indication of one or more thresholds associated with the one or more downlink grant predictions.

17. An apparatus for wireless communications, comprising a processing system that includes one or more processors and one or more memories coupled with the one or more processors, the processing system configured to cause a network node to:
provide, to one or more generative artificial intelligence (AI) language models, input data including information associated with past communications, wherein the one or more generative AI language models are pre-trained based at least in part on training data that includes one or more training tokens associated with a wireless communication protocol;
obtain, from the one or more generative AI language models, output data that includes an indication of one or more downlink grant predictions; and
communicate with one or more UEs based at least in part on the output data.

18. The apparatus of claim 17, wherein to cause the apparatus to communicate, the processing system is configured to cause the network node to:
send, to the one or more UEs, a discontinuous reception (DRX) cycle configuration based at least in part on the output data; and
communicate with at least one of the one or more UEs during an active time period of a DRX cycle associated with the DRX cycle configuration.

19. The apparatus of claim 18, wherein:
the one or more UEs comprises a plurality of UEs;
the output data indicates a future traffic pattern associated with the one or more UEs; and
the DRX cycle configuration indicates one or more time-frequency resource allocations for the active time period of the DRX cycle in accordance with the future traffic pattern.

20. A method for wireless communications by a user equipment, comprising:
providing, to one or more generative artificial intelligence (AI) language models, input data including information associated with past communications, wherein the one or more generative AI language models are pre-trained based at least in part on training data that includes one or more training tokens associated with a wireless communication protocol;
obtaining, from the one or more generative AI language models, output data that includes an indication of one or more downlink grant predictions; and
communicating based at least in part on the output data.
